(19) United States
(12) Patent Application Publication
(10) Pub. No.: US 2026/0190145 A1
(43) Pub. Date: Jul. 2, 2026

(54) COMMUNICATION APPARATUS, METHOD, AND COMPUTER-READABLE STORAGE MEDIUM STORING PROGRAM

(71) Applicant: CANON KABUSHIKI KAISHA, Tokyo (JP)

(72) Inventor: WAHEI SUGAWARA, Kanagawa (JP)

(21) Appl. No.: 19/426,514

(22) Filed: Dec. 19, 2025

(30) Foreign Application Priority Data
Dec. 27, 2024 (JP) 2024-233116

(51) Int. Cl. H04W 74/0816; H04B 17/318; H04W 84/12

(52) U.S. Cl. CPC H04W 74/0816; H04B 17/318; H04W 84/12

(57) ABSTRACT

A communication apparatus includes a control unit that performs control to: in a case of a first status in which communication can be performed by a first communication method via a plurality of access points belonging to a first group, output first type information both indicating specific information relating to the plurality of access points belonging to the first group and indicating a signal strength of a connected access point, and in a case of a second status in which communication can be performed by a second communication method via a plurality of access points belonging to a second group, output second type information indicating a signal strength of a connected access point and not indicating the specific information relating to the plurality of access points belonging to the second group.

### BACKGROUND

### Field of the Technology

The present disclosure relates to a communication apparatus that can execute wireless communication, a method executed by the communication apparatus, and a computer-readable storage medium storing a program.

### Description of the Related Art

In recent years, with increases in the amount of data communication, the development of wireless local area network (LAN) communication techniques and the like has been proceeding. As the main wireless LAN communication standard, IEEE 802.11 standard series is known. The IEEE 802.11 standard series includes standards such as IEEE 802.11a/b/g/n/ac/ax/be, and the like.

Japanese Patent Laid-Open No. 2018-50133 describes a communication apparatus that supports IEEE 802.11a/b/g/n/ac/ax. Studies have also been conducted relating to a multi-AP communication mechanism in which data is transmitted to a station (STA) by cooperation between a plurality of access points (AP).

### SUMMARY

The present disclosure provides a mechanism for enhancing the usability in the case of performing communication via a predetermined communication method.

The present disclosure in one aspect provides a communication apparatus comprising, at least one memory and at least one processor which function as: a communication unit configured to perform wireless LAN communication with a plurality of access points that operate in cooperation and transmit and receive content data; and a control unit configured to perform control to: in a case of a first status in which communication can be performed by a first communication method via a plurality of access points belonging to a first group, output first type information both indicating specific information relating to the plurality of access points belonging to the first group and indicating a signal strength of a connected access point, and in a case of a second status in which communication can be performed by a second communication method via a plurality of access points belonging to a second group, output second type information indicating a signal strength of a connected access point and not indicating the specific information relating to the plurality of access points belonging to the second group.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating a configuration of a wireless communication system.

FIGS. 2A and 2B are diagrams illustrating a configuration of a communication apparatus.

FIGS. 3A to 3D are diagrams illustrating user interface screens.

FIGS. 4A and 4B are diagrams illustrating a configuration of a mobile terminal apparatus.

FIG. 5 is a diagram illustrating a configuration of an access point.

FIG. 6 is a diagram of a sequence between a STA and an AP relating to multi-AP communication.

FIGS. 7A and 7B are flowcharts illustrating processing executed by the communication apparatus.

FIG. 8 is a flowchart illustrating processing executed by the communication apparatus.

FIGS. 9A to 9C are diagrams for describing classification of access point connection statuses.

FIGS. 10A to 10D are diagrams for describing a calculation method for the received signal strength indicator of access point.

FIGS. 11A to 11F are diagrams illustrating icon examples according to access point connection statuses.

FIGS. 12A to 12J are diagrams illustrating icon examples according to access point connection statuses.

FIGS. 13A to 13D are diagrams illustrating icon examples according to access point connection statuses.

FIGS. 14A to 14C are diagrams illustrating examples of displays on an operation display unit of the communication apparatus.

FIGS. 15A to 15B are diagrams illustrating examples of displays on an operation display unit of the mobile terminal apparatus.

FIGS. 16A to 16E are diagrams illustrating printing examples of setting information of the communication apparatus.

FIGS. 17A to 17J are diagrams illustrating examples of operation display units of the communication apparatus and icons.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In multi-AP, there is room for improvement in terms of good communication and usability.

### System Configuration

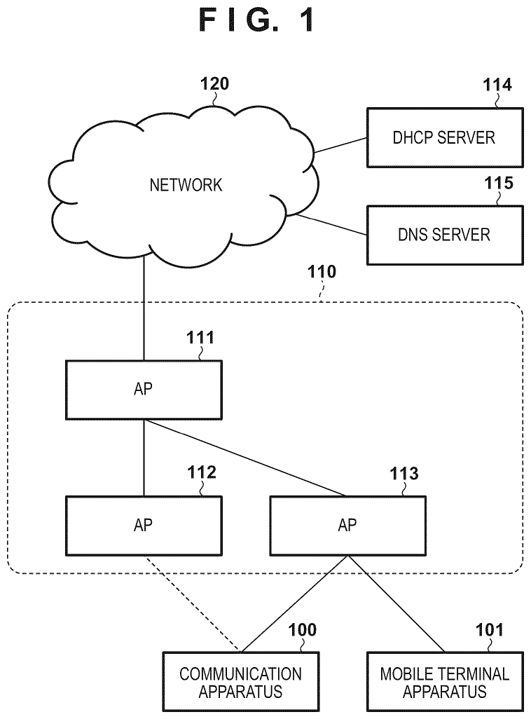

FIG. 1 is a diagram illustrating an example configuration of a system according to the present embodiment. The present system, in this example, is a wireless communication system enabling wireless communication between a plurality of communication apparatuses. The system of FIG. 1 includes a MFP 100 which is a communication apparatus, a mobile terminal apparatus 101, a multi-AP group 110 including a plurality of access points (AP), a DHCP server 114, a DNS server 115, and a network 120. Herein, the multi-AP group 110 is described as including AP 111, AP 112, and AP 113. However, the multi-AP group 110 may include a greater number of APs.

The mobile terminal apparatus 101 is an apparatus with a wireless communication function such as wireless LAN. Note that hereinafter, wireless LAN may be referred to as WLAN. The mobile terminal apparatus 101 may be a personal digital assistant (PDA) or similar personal information terminal, a mobile phone terminal (smartphone), a tablet terminal, a digital camera, a personal computer, or the like.

The MFP 100 is a printing apparatus with a print function and may also have a read function (scanner), a fax function, and a phone function. Also, the MFP 100 according to the present embodiment has a communication function enabling wireless communication with the mobile terminal apparatus 101. Also, in the present embodiment described herein, the MFP 100 is used as an example, but no such limitation is intended. For example, instead of the MFP 100, a scanner apparatus, a projector, a mobile terminal, a smartphone, a note PC, a tablet terminal, a PDA, a digital camera, a music playback device, a television, a smart speaker, or the like with a communication function may be used. Note that MFP is an acronym for multifunction peripheral.

The AP 111 operates as a WLAN base station apparatus provided separated to (outside of) the mobile terminal apparatus 101 and the MFP 100. A communication apparatus with a WLAN communication function can perform communication in WLAN infrastructure mode via the AP 111. Also, infrastructure mode may be referred to as wireless infrastructure mode. The AP 111 wirelessly communicates with a communication apparatus permitted (authenticated) to connect to it, and the communication apparatus relays wireless communication to other communication apparatuses. Also, the AP 111 may be connected to a wired communication network, for example, and relay communication between a communication apparatus connected to this wired communication network and other communication apparatuses wirelessly connected to the AP 111.

The AP 112 and the AP 113 have a similar hardware configuration to the AP 111. Also, the AP 111, the AP 112, and the AP 113 are APs that support multi-AP communication described below and cooperate to form a group (multi-AP group 110).

The DHCP server 114 is connected to the MFP 100 via the AP 111 and the network 120 and provides a service to the MFP 100 by responding to a request from the MFP 100. Note that the DHCP server 114 in FIG. 1 is illustrated as being connected to the AP 111, the AP 112, and the AP 113 as a separated device. However, the AP 111, the AP 112, and the AP 113 may have a DHCP server function.

The DNS server 115 is connected to the MFP 100 and the mobile terminal apparatus 101 via the AP 111 and the network 120 and provides a service for name resolution by responding to a request from the MFP 100 or the mobile terminal apparatus 101. Here, the network 120 may be the so-called Internet, but a closed internal company network or a cellular network may be used.

### MFP External Appearance

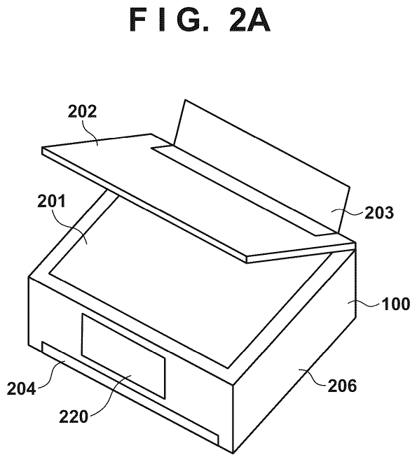

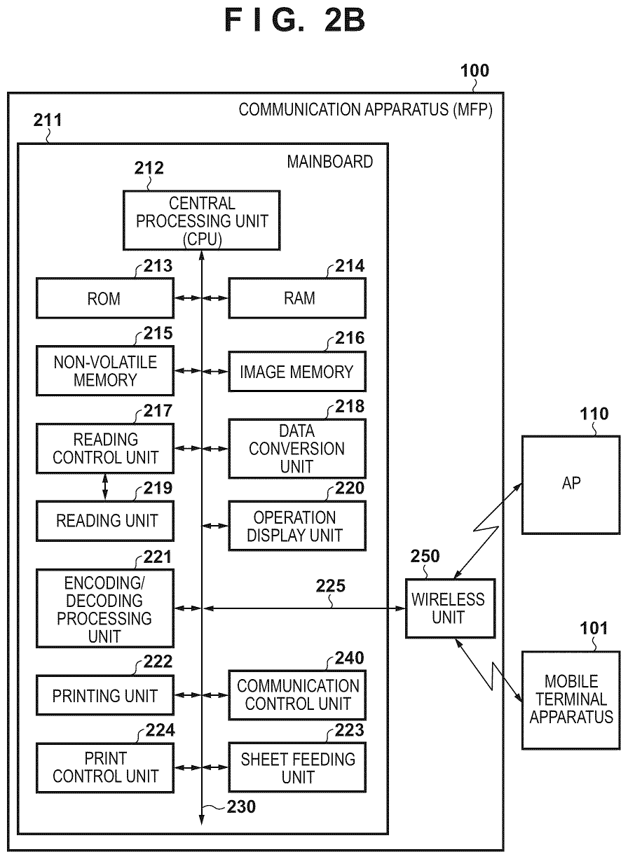

FIG. 2A illustrates an example of the external appearance of the MFP 100. The MFP 100 includes, for example, a platen 201, a document cover 202, a printing paper insertion opening 203, a printing paper discharge opening 204, and an operation display unit 220. The platen 201 is a platform for placing documents to be read. The document cover 202 is a cover used to press against a document placed on the platen 201 or prevent light from a light source illuminating the document escaping out during reading (scanning). The printing paper insertion opening 203 is an insertion opening where various sizes of sheets can be set. The printing paper discharge opening 204 is a discharge opening where sheets are discharged after printing. The sheets set in the printing paper insertion opening 203 are conveyed one sheet at a time to a printing unit and are discharged from the printing paper discharge opening 204 after printing has been performed by the printing unit. The operation display unit 220 includes a touch panel display and is configured to receive operations from the user relating to the activation of various types of functions of an MFP and various types of settings. The operation display unit 220 may include character input keys, a cursor key, an enter key, a cancel key, and/or similar physical keys; LEDs; a LCD; and the like.

The MFP 100 has a WLAN wireless communication function and includes a wireless communication antenna 206 for wireless communication that is not necessarily visible from the outside. The MFP 100 can perform wireless communication via WLAN in a similar manner to the mobile terminal apparatus 101.

### MFP Configuration

FIG. 2B illustrates an example of the configuration of the MFP 100. The MFP 100 includes a mainboard 211 for performing main control of the apparatus itself and a wireless unit 250, which is a single communication module for performing WLAN communication using at least one antenna. Also, the MFP 100 may include a wired LAN unit for performing wired LAN communication, for example.

The mainboard 211 includes, for example, a computation processing unit (CPU) 212, a ROM 213, a RAM 214, a non-volatile memory 215, an image memory 216, a reading control unit 217, a data conversion unit 218, a reading unit 219, and an encoding/decoding processing unit 221. Also, the mainboard 211 includes, for example, a printing unit 222, a sheet feeding unit 223, a print control unit 224, and an operation display unit 220. These functional units in the mainboard 211 are connected to one another via a system bus 230 managed by the CPU 212. Also, the mainboard 211 and the wireless unit 250 are connected via a dedicated bus 225, for example.

The CPU 212 is a system control unit including at least one processor that controls the entire MFP 100. The processing of the MFP 100 described below is, for example, implemented by the CPU 212 executing programs stored in the ROM 213. Note that dedicated hardware may be prepared for each process. The ROM 213 is a non-volatile memory that stores control programs executed by the CPU 212, embedded OS programs, and the like. In the present embodiment, the CPU 212 loads the control programs stored in the ROM 213 into the RAM 214 and executes the control programs under the management of the embedded OS stored in the ROM 213 to perform software control such as scheduling and task switching.

The RAM 214 is volatile memory constituted by an SRAM or the like. The RAM 214 stores data such as program control variables and the like, setting values registered by the user, MFP 100 management data, and the like. Also, the RAM 214 may be used as a buffer for various types of work. The non-volatile memory 215 is constituted by memory such as flash memory, for example, and continually stores data even after power to the MFP 100 is turned off. The image memory 216 is constituted by a memory such as a DRAM. The image memory 216 stores image data received via the wireless unit 250, image data processed by the encoding/decoding processing unit 221, and the like. Note that the memory configuration of the MFP 100 is not limited to the configuration described above. The data conversion unit 218 analyzes data of various formats, converts image data into print data, and the like.

The reading control unit 217 controls the reading unit 219 (for example, a contact image sensor (CIS)) to optically read (scan) the document placed on the platen 201. The reading control unit 217 converts the image obtained by optically reading the document into electrical image data (an image signal) for output. The reading control unit 217 may perform various types of processing such as binarization processing and halftone processing at this time and then output the image data.

The operation display unit 220 includes a touch panel display that displays images on the basis of display control by the CPU 212 and executes generation or the like of a signal in accordance with the reception of a user operation on the touch panel display or a physical operation key.

The encoding/decoding processing unit 221 performs encoding processing and decoding processing and enlargement and reduction processing of image data (JPEG, PNG, and the like) handled by the MFP 100.

The sheet feeding unit 223 holds sheets for printing. The sheet feeding unit 223 can supply sheets that have been set under the control of the print control unit 224. The sheet feeding unit 223 may include a plurality of sheet feeding units for holding a plurality of types of sheets in one apparatus and can control which sheet feeding unit to feed from under the control of the print control unit 224.

The print control unit 224 executes various types of processing such as smoothing processing, print density correction processing, and color correction on the image data to be printed and outputs post-processing image data to the printing unit 222. The printing unit 222 is configured to execute an inkjet printing process by discharging ink supplied from ink tanks from a print head and printing an image on a printing medium such as a sheet. Note that the printing unit 222 may be configured to execute an electrophotographic or other printing process. Also, the print control unit 224 may periodically read out information of the printing unit 222 and update status information such as ink tank remaining amount, print head state, and the like stored in the RAM 214.

The wireless unit 250 is a unit that can provide a WLAN communication function and, for example, can provide a function similar to a wireless unit 401 of the mobile terminal apparatus 101. In other words, the wireless unit 250, following a WLAN protocol, converts data into packets and transmits packets to other devices or restores packets from other external devices to the original data and outputs them to the CPU 212.

The wireless unit 250 can perform communication as a station (hereinafter referred to as STA) compliant with the IEEE 802.11 standard series or an access point (AP). Specifically, the wireless unit 250 can perform communication in compliance with the IEEE 802.11a/b/g/n/ac/ax/be/bn standards. The wireless unit 250 internally includes at least one processor and at least one memory storing a program.

A communication control unit 240 is a unit that controls the communication function of the MFP 100 and that controls the wireless unit 250. The processing of the communication control unit 240 is implemented by the CPU 212 executing a control program stored in the ROM 213. The communication control unit 240 and the wireless unit 250 are connected to one another via the system bus 230 and the dedicated bus 225, for example.

### MFP Operation Display Unit

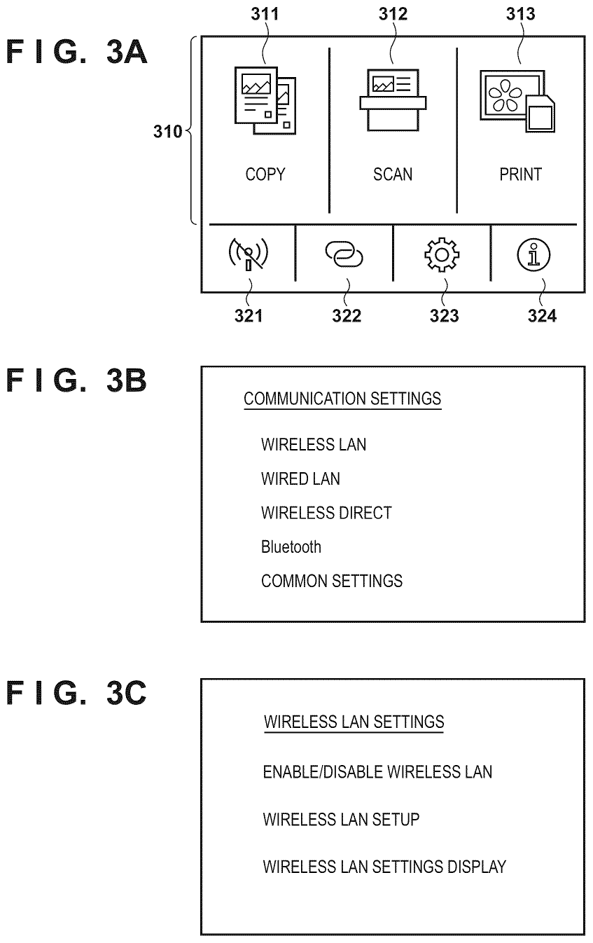

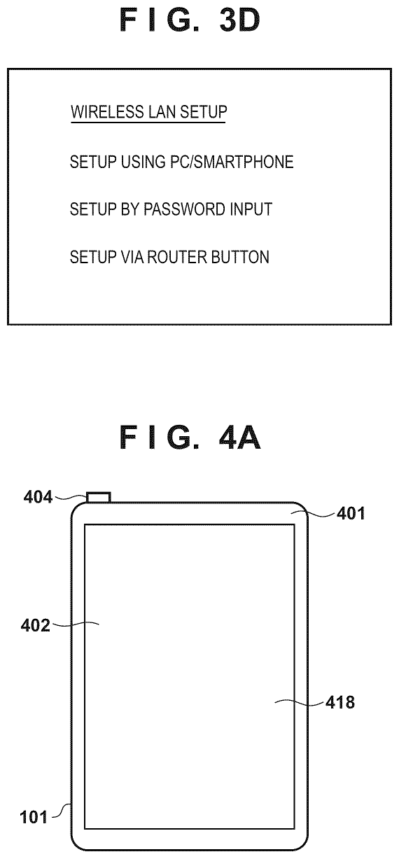

FIGS. 3A to 3D schematically illustrate an example of a screen display on a display (touch panel display) included in the operation display unit 220 of the MFP 100.

FIG. 3A is an example of a home screen displayed when the power of the MFP 100 is turned on and no operations such as printing or scanning are being performed (idle state, standby state). A region 310 in the upper portion of the home screen is a basic menu region where menu items are displayed for selection when issuing an instruction for copying or scanning. In FIG. 3A, icons 311 to 313 corresponding to copy, scan, and print are displayed as a list in the region 310 as menu items (display items) of the basic menu. When each menu item of the basic menu is selected, a corresponding detailed menu is displayed, and the MFP 100 can be caused to execute an operation or function (copy or scan) corresponding to the selected menu item. Menu items different from the icons 311 to 313 can be displayed via an operation (a left or right slide operation to the region 310 or the like) to display another page of the basic menu in the region 310. For example, an icon corresponding to cloud can be displayed. Cloud is a menu item relating to a cloud function using Internet communication.

A network display region 321 is a region for displaying an icon indicating the status of the network. In the illustrated example, in the network display region 321, an icon is displayed that indicates that both wireless infrastructure and wireless direct are disabled. Also, by touching the network display region 321, a communication settings menu can be displayed.

An icon 322 is an operation icon for receiving an instruction to perform setup using a PC or smartphone. When the icon 322 is touched, an operation that is the same as when “Setup via PC/Smartphone” of FIG. 3D described below is selected is performed.

An icon 323 is an operation icon selected when changing settings or performing maintenance of the MFP 100.

FIG. 3B is a display example of a menu screen for communication settings displayed when the network display region 321 on the home screen of FIG. 3A is touched. On the menu screen for communication settings, “Wireless LAN”, “Wired LAN”, “Wireless Direct”, “Bluetooth”, and “Common Settings” are displayed as menu items (options). “Wireless LAN”, “Wired LAN”, and “Wireless Direct” are menu items for LAN settings, and from these items, wired connection settings, wireless infrastructure mode enabled/disabled setting, WFD, softAP mode, or similar P2P mode enabled/disabled setting, and the like can be set.

FIG. 3C is a display example of a wireless LAN settings menu screen displayed when the “Wireless LAN” item on the screen of FIG. 3B is selected. On the wireless LAN settings menu screen, “Enable/Disable Wireless LAN”, “Wireless LAN Setup”, and “Wireless LAN Settings Display” are displayed as menu items (options). When the “Enable/Disable Wireless LAN” item is selected, the enable/disable wireless infrastructure mode setting is switched. When the “Wireless LAN Setup” item is selected, the wireless LAN setup menu of FIG. 3D is displayed. When “Wireless LAN Settings Display” is selected, a detailed screen (wireless LAN settings display screen) displaying details such as the current wireless LAN settings, communication status, and the like is displayed.

FIG. 3D is a display example of a wireless LAN setup menu screen displayed when the “Wireless LAN Setup” item on the screen of FIG. 3C is selected. On the wireless LAN setup menu screen, “Setup via PC/Smartphone”, “Setup by Password Input”, and Setup via Router Button” are displayed as menu items (options). From these items, wireless LAN setup described below including setup using a network setup mode, setup via a password input method, and setup via a push button method can be performed.

### Mobile Terminal Apparatus External Appearance

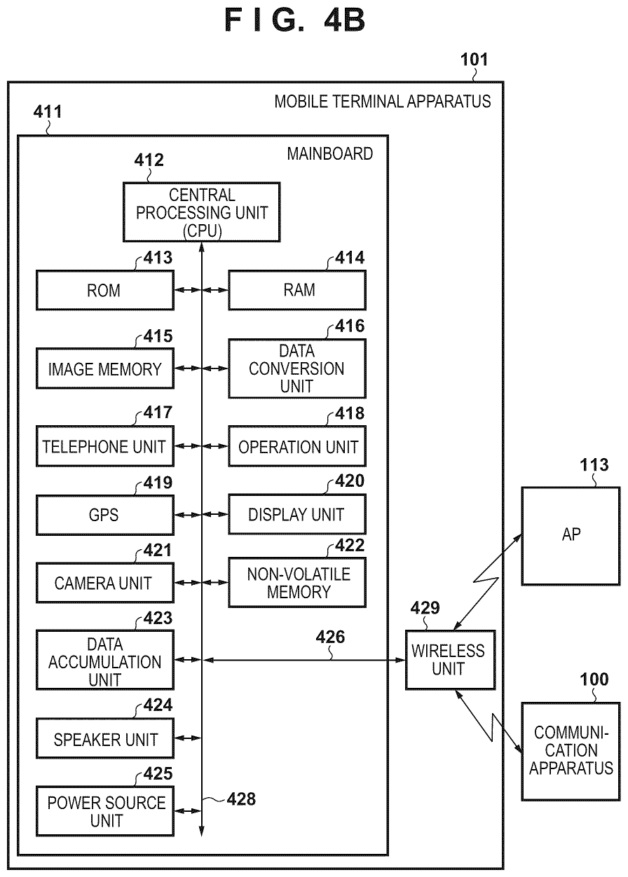

FIG. 4A is a diagram illustrating an example of the external appearance configuration of the mobile terminal apparatus 101. In the present embodiment, in this example, the mobile terminal apparatus 101 is a typical type of smartphone. Note that the mobile terminal apparatus 101, for example, includes a display unit 420, an operation unit 418, and a power key 404. The display unit 420 is a display including an organic electroluminescene (EL) display mechanism or a liquid crystal display (LCD) display mechanism, for example. Note that the display unit 420 may display information using a light-emitting diode (LED), for example. Also, the mobile terminal apparatus 101 may have a function of outputting information via audio in addition to or instead of the display unit 420. The operation unit 418 includes physical keys such as keys and buttons, a touch panel, and the like for detecting a user operation. Note that in the present example, since displaying information on the display unit 420 and receiving user operation via the operation unit 418 is performed using a common touch panel display, the display unit 420 and the operation unit 418 are implemented using a single apparatus. In this case, for example, button icons and a software keyboard are displayed using a display function via the display unit 420, and the user touching these sections is detected by an operation reception function via the operation unit 418. Note that the display unit 420 and the operation unit 418 may be separated, and a piece of hardware for display and a piece of hardware for operation reception may be individually prepared. The power key 404 is a physical key for receiving a user operation for turning the power of the mobile terminal apparatus 101 on or off.

The mobile terminal apparatus 101 includes the wireless unit 401 that provides a WLAN communication function and is not necessarily visible from the outside. The wireless unit 401 is configured to execute data (packet) communication in a WLAN system compliant with the IEEE 802.11 standard series (IEEE 802.11a/b/g/n/ac/ax/be/bn), for example. However, no such limitation is intended, and the wireless unit 401 may be configured to execute WLAN communication compliant with another standard. Note that in this example, the wireless unit 401 can perform communication on both the 2.4 GHz frequency band and the 5 GHz frequency band. However, no such limitation is intended, and the wireless unit 401 may be able to perform communication on one or more frequency bands including the 2.4 GHz frequency band, the 5 GHz frequency band, and the 6 GHz frequency band. Also, the wireless unit 401 can execute communication based on WFD, communication using a SoftAP mode, communication using a wireless infrastructure mode, and the like. Operations in these modes will be described below.

### Mobile Terminal Apparatus Configuration

FIG. 4B illustrates an example of the configuration of the mobile terminal apparatus 101. The mobile terminal apparatus 101 in this example includes a mainboard 411 for executing main control of the apparatus itself and a wireless unit 429 for WLAN communication. The mainboard 411 includes, for example, a CPU 412, a ROM 413, a RAM 414, an image memory 415, a data conversion unit 416, a telephone unit 417, a GPS 419, a camera unit 421, a non-volatile memory 422, a data accumulation unit 423, a speaker unit 424, and a power source unit 425. Here, CPU is an acronym for central processing unit, ROM is an acronym for read only memory, RAM is an acronym for random access memory, and GPS is an acronym for global positioning system. The mobile terminal apparatus 101 also includes a display unit 420 and an operation unit 418. Each functional unit in the mainboard 411 is connected to one another via a system bus 428 managed by the CPU 412. Also, the mainboard 411 and the wireless unit 429 (the wireless unit 401 described above) are connected via a dedicated bus 426, for example.

The CPU 412 is a system control unit including at least one processor that controls the entire mobile terminal apparatus 101. The processing of the mobile terminal apparatus 101 described below is, for example, implemented by the CPU 412 executing programs stored in the ROM 413. Note that dedicated hardware may be prepared for each process. The ROM 413 stores a control program executed by the CPU 412, an embedded operating system (OS) program, and the like. In the present embodiment, in a similar manner, the CPU 412 executes the control programs stored in the ROM 413 under the management of the embedded OS stored in the ROM 413 to perform software control such as scheduling and task switching.

The RAM 414 is constituted by a Static RAM (SRAM) or the like. The RAM 414 stores data such as program control variables and the like, setting values registered by the user, mobile terminal apparatus 101 management data, and the like. Also, the RAM 414 may be used as a buffer for various types of work. The image memory 415 is constituted by a memory such as a Dynamic RAM (DRAM). The image memory 415 temporarily stores image data received via the wireless unit 429 and image data read out from the data accumulation unit 423 for processing by the CPU 412. The non-volatile memory 422 is constituted by memory such as flash memory, for example, and continually stores data even after power to the mobile terminal apparatus 101 is turned off. Note that the memory configuration of the mobile terminal apparatus 101 is not limited to the configuration described above. For example, the image memory 415 and the RAM 414 may be shared, and data backup and the like may be performed using the data accumulation unit 423. Also, in the present embodiment, DRAM was given as an example of the image memory 415. However, another storage medium such as a hard disk or a non-volatile memory may be used.

The data conversion unit 416 executes analysis of data of various formats and data conversion, such as color conversion and image conversion. The telephone unit 417 performs control of a telephone line and implements telephone communication by processing audio data input/output via the speaker unit 424. The GPS 419 receives radio waves sent from satellites and obtains position information, for example the current latitude and longitude of the mobile terminal apparatus 101.

The camera unit 421 has a function of electronically recording and encoding an image input via a lens. The image data obtained via image capture by the camera unit 421 is stored in the data accumulation unit 423. The speaker unit 424 performs control to implement a function of inputting or outputting audio for the telephone function, as well as an alarm notification and the like. The power source unit 425 is a portable battery that controls power supply to the apparatus, for example. Power source states include, for example, a battery dead state in which the battery has no remaining amount, a power-off state in which the power key 404 is not pressed, an active state in which the apparatus is normally active, and a power saving state in which the apparatus is active but is set in a power saving mode.

The display unit 420 displays various types of input operations, the operation situation of the MFP 100, status situations, and the like on the basis of control by the CPU 412. The operation unit 418 performs control including generating an electrical signal corresponding to a received user operation and outputting the electrical signal to the CPU 412.

The mobile terminal apparatus 101 can perform wireless communication using the wireless unit 429 and perform data communication with another device such as the MFP 100. The wireless unit 429 converts the data into packets and transmits the packets to the other device. Also, the wireless unit 429 restores a packet from an external other device into the original data and outputs this to the CPU 412. The wireless unit 429 is a unit for implementing communication compliant with the WLAN standards. The wireless unit 429 can operate in at least two communication modes in parallel, the at least two communication modes including wireless infrastructure mode and P2P (WLAN) mode. Note that the frequency range used in these communication modes may be restricted by the functions and performance of the hardware.

### Access Point Configuration

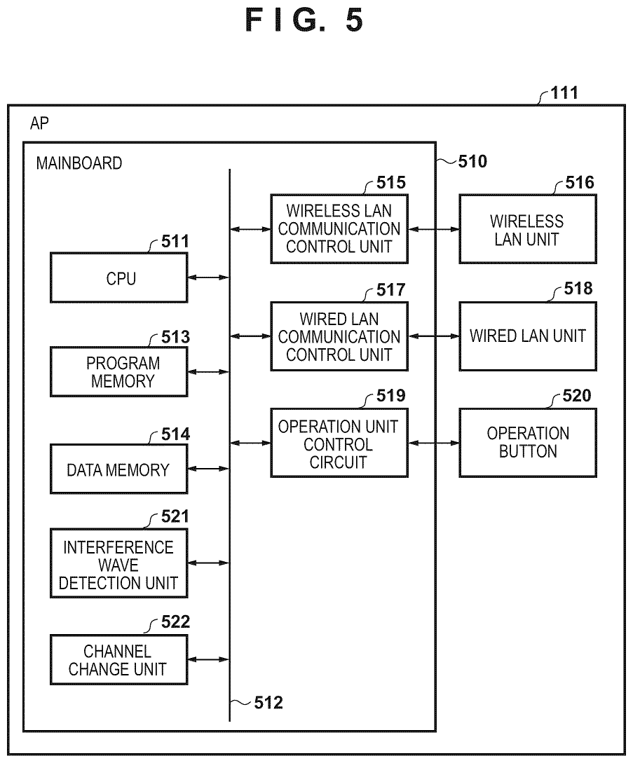

FIG. 5 is a block diagram illustrating the configuration of the AP 111 with a wireless LAN access point function. The AP 111 includes a mainboard 510 for performing control of the AP 111, a wireless LAN unit 516, a wired LAN unit 518, and an operation button 520.

A CPU 511 in the form of a microprocessor disposed on the mainboard 510 operates according to a control program stored in a program memory 513 in the form of ROM connected via an internal bus 512, the content of a data memory 514 in the form of RAM, and the like. The CPU 511 performs wireless LAN communication with other communication terminal apparatuses by controlling the wireless LAN unit 516 via a wireless LAN communication control unit 515. Specifically, the wireless LAN unit 516 is configured to execute data (packet) communication in a WLAN system compliant with the IEEE 802.11 standard series (IEEE 802.11a/b/g/n/ac/ax/be/bn), for example, as wireless LAN communication. Also, communication is possible as an AP supporting multi-AP communication described below. However, no such limitation is intended, and the wireless LAN unit 516 may be configured to execute WLAN communication compliant with another standard. Note that in this example, the wireless LAN unit 516 can perform communication on a frequency band such as the 2.4 GHz frequency band, the 5 GHz frequency band, and the 6 GHz frequency band. However, no such limitation is intended, and the wireless LAN unit 516 may be able to perform communication on one or more frequency bands including the 2.4 GHz frequency band, the 5 GHz frequency band, and the 6 GHz frequency band.

Also, the CPU 511 performs wired LAN communication with other communication apparatuses by controlling the wired LAN unit 518 via a wired LAN communication control unit 517. The CPU 511 can receive operations from the user via the operation button 520 by controlling an operation unit control circuit 519. The CPU 511 includes at least one processor.

Also, the AP 111 includes an interference wave detection unit 521 and a channel change unit 522. The interference wave detection unit 521 executes interference detection processing during wireless communication in a band where dynamic frequency selection (DFS) is performed. The channel change unit 522 executes processing to change the channel to use when an interference wave is detected, when an empty channel needs to be immediately changed to, and the like during wireless communication in a band where DFS is performed.

Note that the AP 112 and the AP 113 have a configuration similar to that of the AP 111.

### P2P Mode (Direct Mode)

Next, in WLAN communication, the P2P (WLAN) communication method for apparatuses to wirelessly communicate directly bypassing an external access point will be described. P2P (WLAN) communication can be implemented using a plurality of methods. For example, a communication apparatus can support a plurality of modes for P2P (WLAN) communication and can perform P2P (WLAN) communication selectively using one of the plurality of modes.

The following two modes are examples of P2P modes.
SoftAP mode
Wi-Fi Direct (WFD) mode

The communication apparatus that can execute P2P communication may be configured to support at least one of the plurality of modes. On the other hand, a communication apparatus that can perform P2P communication does not mean that all of the modes are supported, and the communication apparatus may be configured to only support a portion of the modes.

With a communication apparatus (for example, the mobile terminal apparatus 104) having a communication function using WFD, when a user operation is received via the operation unit, an application (dedicated in some cases) for implementing the communication function is invoked. Then, the communication apparatus displays a user interface (UI) screen provided by the application and prompts for a user operation. WFD communication may be performed on the basis of the user operation received in response to this.

### SoftAP Mode

In softAP mode, the communication apparatus (for example, the mobile terminal apparatus 101) operates as a client that requests the various types of service. Another communication apparatus (for example, the MFP 100) operates as a soft AP that can execute a WLAN AP function set by the software. Note that it is sufficient that the commands and parameters transmitted and received when establishing a wireless connection between the client and the soft AP are as specified by Wi-Fi (registered trademark) standards, and thus description thereof will be omitted. Also, the MFP 100 that operates in the softAP mode determines the frequency band and the frequency channel as a master station. Thus, the MFP 100 can select which frequency range to use from among the 5 GHz frequency band and the 2.4 GHz frequency band and which frequency channel to use in the frequency band.

### WFD Mode

The MFP 100 may be configured to constantly active as a WFD mode master station (autonomous group owner). This makes GO Negotiation processing for determining roles unnecessary. Also, in this case, the MFP 100 determines the frequency band and the frequency channel as a master station. Thus, the MFP 100 can select which frequency range to use from among the 5 GHz frequency band and the 2.4 GHz frequency band and which frequency channel to use in the frequency band.

### Wireless Infrastructure Mode

In the wireless infrastructure mode, the communication apparatuses (for example, the mobile terminal apparatus 101 and the MFP 100) that perform communication with one another are connected to an external AP (for example, the AP 111) controlling the network, and communication between the communication apparatuses is performed via the AP. In other words, communication between the communication apparatuses is performed via the network formed by the external AP. The mobile terminal apparatus 101 and the MFP 100 each discover the AP 111, transmit a connection request to the AP 111, and connect to the AP 111. This enables communication between the communication apparatuses in the wireless infrastructure mode via the AP 111. Note that the plurality of communication apparatuses may connect to different APs. In this case, the communication apparatuses can perform communication by data being transferred between APs. Note that it is sufficient that the commands and parameters transmitted and received when the communication apparatuses perform communication via the access point are as specified by Wi-Fi standards, and thus description thereof will be omitted. Also, in this case, the AP 111 determines the frequency band and the frequency channel. Thus, the AP 111 can select which frequency range to use from among the 5 GHz frequency band, the 2.4 GHz frequency band, and the 6 GHz frequency band and which frequency channel to use in the frequency band.

### Multi-AP Communication

With the IEEE 802.11be standard, a single access point (AP) establishes a plurality of links with a single station (STA) via a plurality of different frequency channels and multi-link communication for performing communication in parallel is standardized.

Also, with the IEEE 802.11bn standard, which is a successor standard of the IEEE 802.11be standard, studies have been conducted into enhancing usability using multi-AP communication.

An example includes distributed MIMO technology based on multi-user multi-output (MIMO) technology in which a plurality of transmission and reception antennas are used at the same time via the same channel. With distributed MIMO, in an environment in which a plurality of APs and a plurality of STAs exist, a group is formed between APs, information relating to the communication state and the status of each AP is shared, and data is transmitted to an STA from the plurality of APs in parallel at the same time. By the plurality of APs performing joint transmission, the number of spatial streams can be increased compared to a case of a single AP. Thus, throughput can be expected to be enhanced.

Another example includes a technology for enhancing the reception quality at a STA via temporal diversity and spatial diversity by the plurality of APs transmitting the data to the STA at different timing in a time-divisional manner.

This communication technology in which a plurality of APs form a group and cooperate is referred to as multi-AP communication. The APs are classified into a single coordinator AP that manages all of the APs and coordinated APs that operate under the management of the coordinator AP.

Hereinafter, in describing multi-AP communication, an AP that manages APs will be referred to as “coordinator AP” or “sharing AP”. An AP operating under the management of the coordinator AP will be referred to as “coordinated AP” or “shared AP”. Also, the coordinator AP and the coordinated AP can transmit and receive signals with one another. Each of the plurality of APs including the AP 111 to the AP 113 may be wirelessly connected and perform wireless LAN communication or may have a wired connection and perform wired LAN communication. Note that the AP 111 to the AP 113 can perform multi-AP communication compliant with the IEEE 802.11 series standards and support a configuration in which a plurality of APs cooperate to perform communication with a shared single STA.

Examples of a multi-AP communication method include the Co-OFDMA method and the Joint-TX method. The coordinated-orthogonal frequency division multiple access (Co-OFDMA) method includes dividing the usable frequency resources between a plurality of basic service sets (BSS). For example, a frequency resource used by the AP 112 and the MFP 100 (STA) and a frequency resource used by the AP 113 and the MFP 100 (STA) are divided so that they do not overlap with one another. This can prevent interference between BSS communications. In a case where the STA has the capability to simultaneously transmit and receive using a plurality of frequency bands (a plurality of units on the same channel or across different channels, a plurality of channels, or a plurality from among the 2.4 GHz frequency band, the 5 GHz frequency band, and the 6 GHz frequency band), the plurality of APs can cooperate and exchange data with the same STA. Data corresponds to content data including image data, audio data, document data, print data, and the like. In this case, transmission of packet 1 of content A from the AP 112 to the MFP 100 (STA) and transmission of packet 2 of content A from the AP 113 to the MFP 100 (STA) can be performed in parallel.

In the joint-transmission (Joint-TX) method, the same signal can be exchanged between a plurality of APs and a single STA. At this time, control is performed so that a multiplex wave (overlapped radio waves, multiplexed radio waves, combined waves) combined to amplify the radio waves output from the plurality of APs is received by the STA. In this manner, control is performed so that a signal (amplified signal) that is stronger than a signal from just one AP is received by the STA. For example, between the AP 112 and the MFP 100 (STA) and between the AP 113 and the MFP 100 (STA), the same signal is multiplexed and exchanged so that it is amplified at the position of the MFP 100 (STA). For example, at the same timing, packet 1 of content A is transmitted from the AP 112 to the MFP 100 (STA) and packet 1 of content A is transmitted from the AP 113 to the MFP 100 (STA). At this time, the radio wave of content A is transmitted so that it is multiplexed at the position of the MFP 100 (STA). This can enhance the reliability (connectivity) of communication between the STA and the AP and enhance the speed of data exchange.

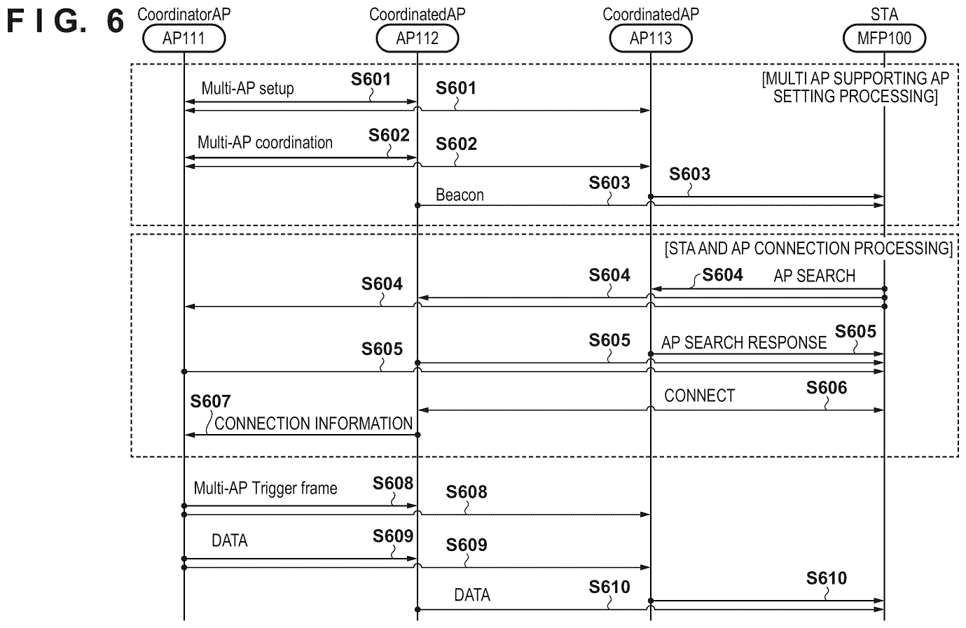

FIG. 6 is a sequence diagram illustrating an example of processing in which the AP 111 operates as the coordinator AP, the AP 112 and the AP 113 as coordinated APs cooperate, and data is exchanged with the MFP 100 (STA). The processing executed by each apparatus in the present sequence is implemented by the CPU of each apparatus reading out to the RAM and executing various types of programs stored in the ROM or similar memory of each apparatus.

In S601, the AP 111 to the AP 113 execute multi-AP setup processing. In multi-AP setup processing, the capability information and parameters are exchanged between the APs, and group formation is performed for multi-AP communication.

In S602, between the AP 111 to the AP 113, multi-AP coordination processing is executed. For example, the multi-AP communication method is determined, the roles of the APs (coordinator AP or coordinated AP) are determined, and parameters and network information are exchanged between APs. Determining the multi-AP communication method and determining the roles of the APs may be determined by exchanging and comparing parameters between the AP 111 to the AP 113. At this time, the coordinator AP (AP 111) transmits the network information (the SSID to be shared in use, the basic service set color ID (BSSID) to be shared in use, or the like) to the coordinated AP (AP 112 and AP 113). Note that the communication of the BSSID to be shared in use is performed in the case of the joint-TX method.

In S603, the AP 112 and the AP 113 transmit a beacon frame (information voluntarily and periodically transmitted by the AP) according to the network information transmitted in S602. The beacon frame includes information indicating that multi-AP communication can be executed by the connected STA and information indicating the multi-AP communication method. A multi-AP information element (IE) may be provided for transmission in the beacon frame to be transmitted by the AP that supports multi-AP communication. The multi-AP IE includes at least one of the following information (one or more of the following information):
SSID to be used by a plurality of coordinated APs belonging to the same multi-AP group (ESSID to be shared in use transmitted in S602)
BSSID (BSSID to be shared in use by the APs belonging to the multi-AP group 110 transmitted in S602 in the case of the joint-TX method)
BSS color value (identifier) for multi-AP communication
Operation wireless channel (may include communication channel to be shared in use in the case of the joint-TX method, communication channel and/or resource unit used by the transmission source AP in the case of the Co-OFDMA method, and communication channel and/or resource unit used by other APs in the multi-AP group 110 in the case of the Co-OFDMA method)
Multi-AP communication method (information specifying either the Co-OFDMA method or the joint-TX method)

Note that the information storage method and configuration are not limited to these examples, and similar information may be stored and transmitted using a similar format. Note that multi-AP IE may be alternatively referred to as multi-AP element or the like. Also, the multi-AP IE may be included in a probe response of S605 or a different radio frame such as an action frame or the like.

In S604, the MFP 100 (STA) starts the establishment of a connection with the APs in a wireless infrastructure mode. The MFP 100 (STA) starts searching for APs by transmitting a probe request frame in order to determine whether there is an AP that supports multi-AP communication.

In S605, the MFP 100 (STA) searches for and finds an AP by receiving a probe response frame or a beacon frame transmitted from an AP, which is a response to an AP search.

In S606, the MFP 100 (STA) executes connection processing with at least one coordinated AP on the basis of the information included in the frame received in S605. Here, for example, the MFP 100 (STA) transmits a connection request to the AP 112 and executes a connection attempt (connection processing). The connection processing here includes authentication and association processing as specified in IEEE 802.11, for example. The MFP 100 (STA) may provide a multi-AP IE to an association request frame to be transmitted to indicate a request for multi-AP communication. The AP 112 that receives the association request frame transmits an association response frame as a response. In this manner, the MFP 100 (STA) and the AP 112 establish a wireless LAN connection.

In S607, in a case where the AP 112 has established a connection with the MFP 100 (STA), the AP 112 transmits to the Coordinator AP (AP 111) both information indicating a connected state with the MFP 100 (STA) and connection parameters relating to the connected MFP 100 (STA). The connection parameters relating to the connected MFP 100 (STA) include information (information required for PMK caching and roaming, authentication information, and the like) used at the time of connection processing between the AP 112 and the MFP 100 or generated at the time of connection processing, an STA identifier, and the like. Note that in a case where the AP 113 and the MFP 100 (STA) are connected, in a similar manner, the AP 113 notifies that a connected state has been established to the Coordinator AP (AP 111).

After S607, the connection parameters relating to the MFP 100 (STA) transmitted in S607 are transmitted from the AP 111 to the AP 113. The AP 113 may use the transmitted connection parameters relating to the MFP 100 (STA) to execute processing to establish a connection with the MFP 100. However, in the case of the joint-TX method, data can also be transmitted from an AP without an established connection. In other words, an AP without an established connection may be a multiplexed radio wave transmission source. Thus, the processing for establishing a connection between the AP 113 and the MFP 100 may not be executed.

In S608, the coordinator AP (AP 111) determines the transmission parameters (information required for determining the transmission timing and transmission output for each coordinated AP and each antenna and/or resource unit allocation information and the like) on the basis of the connection parameters (parameters received in S607) of the coordinated AP in a connected state with the MFP 100 (STA) and thereafter performs transmission data allocation. The information of the determined transmission parameters is transmitted to each coordinated AP via a multi-AP trigger frame. The AP 112 and the AP 113 set their transmission parameters (transmission timing and output and resource units to use) on the basis of the transmitted information. Note that the multi-AP trigger frame may be referred to by a different name. Also, the multi-AP trigger frame may be an extended trigger frame of the IEEE 802.11ax/be standard.

In S609, the coordinator AP (AP 111) transmits, to the coordinated APs, transmission target data (for example, image data, document data, print data, or similar content data) to be sent to the MFP 100 (STA).

In S610, when the coordinated APs (the APs 112 and 113) receive the transmission target data from the coordinator AP (AP 111), the coordinated APs cooperate relating to the transmission target data and transmit it to the MFP 100. Also, when the coordinated APs (the APs 112 and 113) receive data from the MFP 100 (STA), the coordinated APs transmit the received data to the coordinator AP (AP 111). Note that this order of data exchange is an example, and for example, reception of the data from the STA may be performed before transmission of the data to the STA.

Note that the coordinator AP may directly exchange signals with the STA. For example, the AP 111 may operate as a coordinator AP or a coordinated AP. In this case, for example, the AP 111, while exchanging radio frames with the STA, may issue an instruction to the AP 112 or the AP 113 to cause an exchange of radio frames between the AP 112 or the AP 113 and the STA. Note that in a case where the coordinator AP causes a radio frame to be transmitted from the coordinated AP, the coordinator AP may transmit the transmission target data to the coordinated AP. However, no such limitation is intended, and the coordinated AP may directly obtain the transmission target data from the Internet, for example. Also, the coordinator AP may receive, from the coordinated AP, the data received by the coordinated AP from the STA, but the coordinated AP may transfer the data received from the STA to the STA partner apparatus without transferring the data to the coordinator AP.

Note that all of the APs in the same network can operate as a coordinator AP, and one of the APs may be determined to operate as the coordinator AP via a certain criteria. Note that the coordinator AP may not operate as an AP that transmits a beacon frame and may execute only the role of a coordinator AP which includes sending instructions to each AP and the like. Also, each AP may include a plurality of the wireless LAN communication control units 515 and operate as a plurality of coordinated APs. Also, the coordinator AP may be implemented as a logical function, and a single physical AP may operate as one or more coordinated APs while also operating as the coordinator AP.

Processing for dynamically switching the display method of information relating to the APs connected to the MFP 100 according to the communication method with the APs will now be described. The information relating to the APs includes information indicating the signal strength of connected APs as described below.

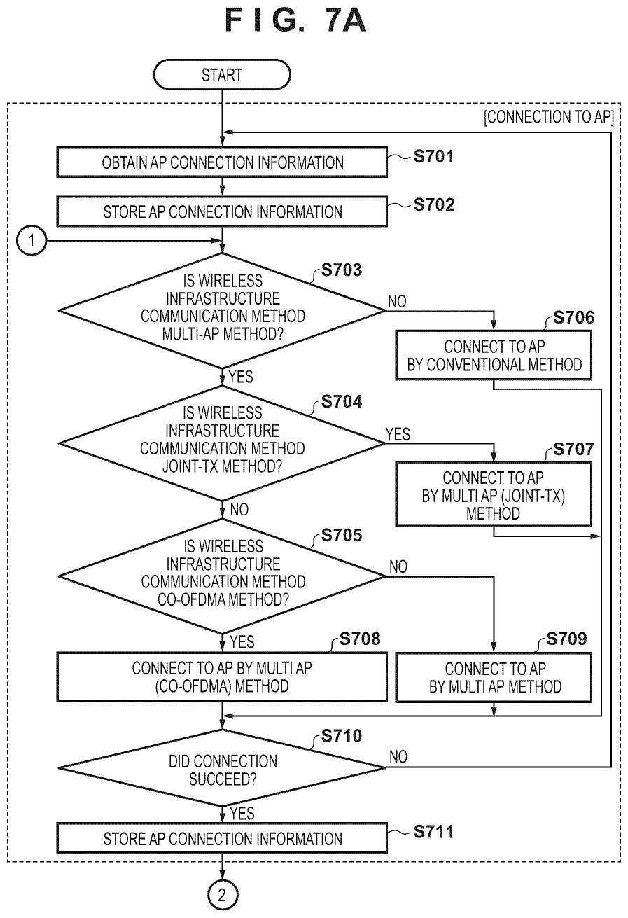

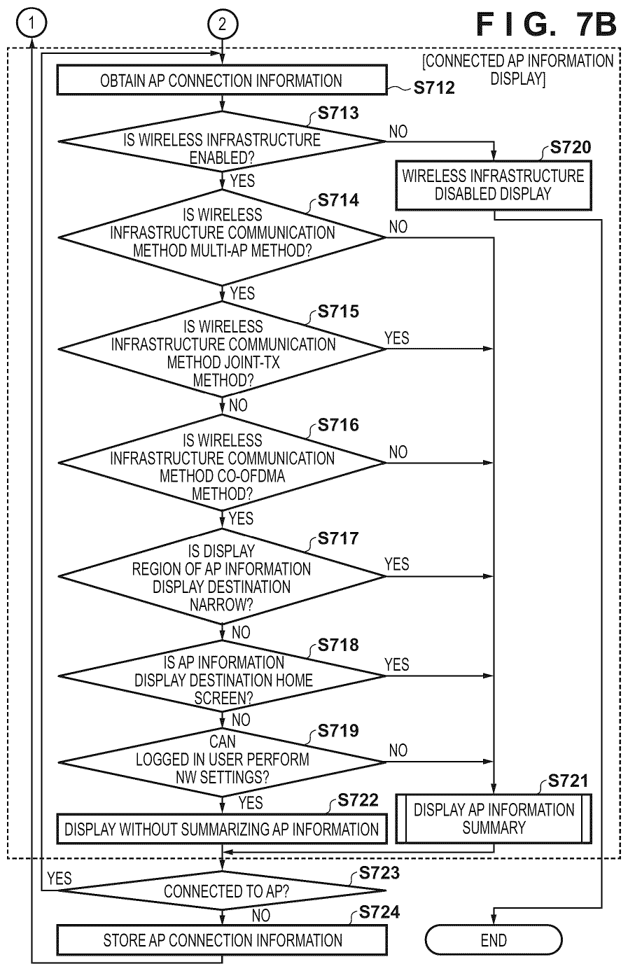

FIGS. 7A and 7B are flowcharts illustrating processing (S701 to S711) for connecting the MFP 100 to the APs and processing (S712 to S722) for displaying information relating to the APs connected to the MFP 100 according to the AP communication method. The processing in the flowchart illustrated in FIGS. 7A and 7B are implemented by the CPU 212 of the MFP 100 loading various types of programs stored in the computer-readable memory of the ROM 213 onto the RAM 214 and executing the programs.

Note that the present processing is started when the MFP 100 is activated or the communication mode is activated. Also, the present processing is started when the MFP 100 is powered up on the basis of a user operation of the MFP 100, for example. Also, the present processing is started on the basis of the “Wireless LAN Setup” item being selected on the screen of FIG. 3C displayed on the operation display unit 220 and via a user operation or the like for starting wireless infrastructure mode settings. Also, the present processing may be started when a specific signal is received from an external apparatus such as the mobile terminal apparatus 101. Also, the present processing may be started in a case where the radio wave environment deteriorates and the connection status between the MFP 100 and an external AP deteriorates and an AP as the connection destination is re-determined. Also, the present processing may be started when the communication method to be used for communication between the MFP 100 and an external AP is changed. Also, the processing of S712 to S723 of FIG. 7B may be periodically executed in a case where the MFP 100 is connected to an AP and may be executed in a case where the connection status between the MFP 100 and an AP is changed.

In S701, the CPU 212 obtains AP information required for wireless infrastructure mode settings. The CPU 212 obtains the AP information by searching for an AP via the MFP 100. Specifically, in S701, the CPU 212 starts searching for an AP by transmitting a probe request. This processing corresponds to the processing of S604 of FIG. 6 described above.

Thereafter, when the CPU 212 receives a probe response or a beacon (information autonomously and periodically transmitted by the AP) transmitted from an AP, the CPU 212 searches for and finds the AP. This processing corresponds to the processing of S605 of FIG. 6 described above.

The information obtained from the AP via the AP search of S701 includes at least one or more of information indicating the SSID of the AP, the received signal strength indicator (RSSI), the signal-noise ratio (SNR), the link speed, the frequency band, the MAC address, the authentication method, the encryption method, the multi-AP-related information (multi-AP IE) described with reference to FIG. 6, and the like. Note that the contents of the information obtained from the AP in the present processing are different depending on the model, model number, settings, and the like of the AP. Also, in a case where the AP does not support the security method (authentication method, encryption method) supported by the MFP 100, the corresponding AP information may be excluded from the searching result. Also, in a case where the MFP 100 does not support the security method supported by the AP and/or the security method supported by the AP is restricted by the MFP 100, the corresponding AP information may be excluded from the search result.

Also, in S701, after completion of the AP search, the CPU 212 displays an AP list on the operation display unit 220 of the MFP 100 and receives an input of the password for the AP selected by the user.

Note that the AP information in S701 may be obtained from an AP using the function called Wi-Fi Easy Connect (WEC) (registered trademark). Also, the AP information in S701 may be obtained from an AP using the function called Wi-Fi Protected Setup (WPS) (registered trademark). The AP information in S701 may be obtained by receiving a specific signal from an external apparatus such as the mobile terminal apparatus 104. Also, in a case where the AP information has already been stored via a processing described below, the CPU 212 may obtain the AP information from the RAM 214 and/or the non-volatile memory 215 of the MFP 100.

In S702, the CPU 212 stores the AP information required for the wireless infrastructure mode settings in the RAM 214 and/or the non-volatile memory 215 on the basis of the information obtained in S701. In S702, the information stored in the memory such as the RAM 214 includes at least one of information indicating the SSID of the AP, the received signal strength indicator, the signal-noise ratio, the link speed, the frequency band, the MAC address, the authentication method, the encryption method, the multi-AP-related information (Multi-AP IE), and the like.

Next, in S703 to S709, the CPU 212 uses the AP information stored in the memory such as the RAM 214 in S702 and executes processing to connect to the AP according to the IEEE 802.11 standard. This processing corresponds to the processing of S606 of FIG. 6 described above.

In S703 to S705, the CPU 212 determines the communication method supported by the connection target AP. Thereafter, in S706 to S709, the CPU 212 executes connection processing with the AP.

In S703, the CPU 212 determines whether or not the AP can perform multi-AP communication. Whether or not the AP can perform multi-AP communication is determined on the basis of the information obtained from the AP as described with reference to FIG. 6. For example, in the processing of S701, in a case where the beacon frame (information voluntarily and periodically transmitted by the AP) or the probe response received from the AP includes a multi-AP IE, the CPU 212 determines that the AP can perform multi-AP communication, and the processing advances to S704. Otherwise, the processing advances to S706.

In S704, the CPU 212 determines whether or not the AP can perform communication using the joint-TX method of multi-AP communication. Whether or not the AP can perform the joint-TX method is determined on the basis of the information obtained from the AP in a similar manner as in S703. For example, it is determined on the basis of the value of a multi-AP IE included in a beacon frame or probe response received from the AP in S701. In a case where the CPU 212 determines that the AP can perform communication via the joint-TX method, the processing advances to S707. Otherwise, the processing advances to S705.

In S705, the CPU 212 determines whether or not the AP can perform communication using the Co-OFDMA method of multi-AP communication. Whether or not the AP can perform the Co-OFDMA method is determined on the basis of the information obtained from the AP in a similar manner as in S704. In S705, for example, the CPU 212 determines this on the basis of the value of a multi-AP IE included in a beacon frame or probe response received from the AP in S701. In a case where the CPU 212 determines that the AP can perform communication via the Co-OFDMA method, the processing advances to S708. Otherwise, the processing advances to S709.

In S706, the CPU 212 uses the AP information stored in the memory such as the RAM 214 in S702 and executes processing to connect to the AP according to the IEEE 802.11 standard. Note that the connection processing with the AP in S706 may be connection processing compliant with at least one standard from among any of IEEE 802.11a/b/g/n/ac/ax/be.

In S707, the CPU 212 uses the AP information stored in the memory such as the RAM 214 in S702 and executes processing to connect to the AP according to the IEEE 802.11 standard. Specifically, in S707, the CPU 212 executes processing to connect to the AP using the joint-TX method of multi-AP communication.

In S708, the CPU 212 uses the AP information stored in the memory such as the RAM 214 in S702 and executes processing to connect to the AP according to the IEEE 802.11 standard. Specifically, in S708, the CPU 212 executes processing to connect to the AP using the Co-OFDMA method of multi-AP communication.

In S709, the CPU 212 uses the AP information stored in the memory such as the RAM 214 in S702 and executes processing to connect to the AP according to the IEEE 802.11 standard. Specifically, in S709, the CPU 212 executes processing to connect to the AP using multi-AP communication of a different method from the joint-TX method and the Co-OFDMA method.

In S710, the CPU 212 determines whether or not connection between the MFP 100 and the AP has been successful via any of the connection processing of S706 to S709. In a case where the CPU 212 determines that connection has been successful, the processing advances to S711. On the other hand, in a case where the CPU 212 determines that the connection has failed, the processing returns to S701, and obtaining of the connection information of an AP and connecting with an AP is performed again. Note that depending on the reason for connection with the AP failing, the CPU 212 may skip the processing of S701 and/or S702. For example, in a case where the CPU 212 determines that connection has failed due to an AP not being found in S710, AP information previously stored in the memory such as the RAM 214 in S702 may be used to re-attempt connection with an AP.

In S711, the CPU 212 stores the AP information in the RAM 214 and/or the non-volatile memory 215 on the basis of the information obtained from the AP in the connection processing with the AP of any of S706 to S709 as in S702. The AP information stored in the memory such as the RAM 214 in S711 includes at least one of information indicating the connection status (connected) with the AP, the security method, the frequency band, the MAC address of the AP, the IPv4 address allocated to the MFP 100, the IPv6 address, the received signal strength indicator, the signal-noise ratio, the link speed, the multi-AP communication method, and the like.

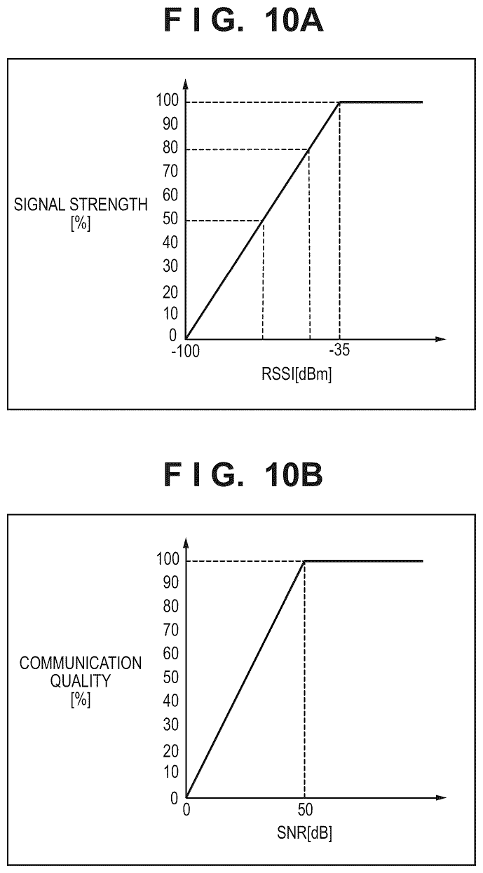

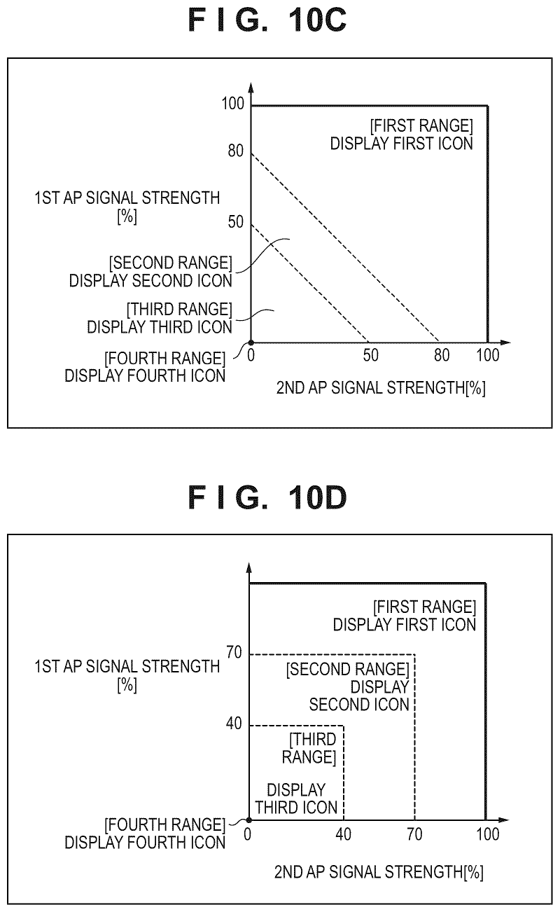

Note that regarding the received signal strength indicator of the AP, the RSSI obtained from the wireless unit 250 at the time of connection with the AP may be stored as a value obtained via conversion using a predetermined method. For example, as illustrated in FIG. 10A, so that the RSSI is 0% at −100 dBm or less, 20% at −85 dBm, and 100% at −35 dBm or greater, the converted value may be stored.

Also, the communication quality may be stored as a value obtained via conversion of the SNR using a predetermined method. For example, as illustrated in FIG. 10B, so that the SNR is 0% at 0 dB or less and 100% at 50 dB or greater, the converted value may be stored.

S712 to S722 of FIG. 7B correspond to processing for displaying the information of AP the MFP 100 has connected to.

In S712, to determine the display method of the information indicating the signal strength of the AP the MFP 100 is connected to, the CPU 212 starts confirming the operation status of the communication mode of the MFP 100 and the connection status between the MFP 100 and the AP. In S712, the CPU 212 obtains information of the connection with the AP. Specifically, the CPU 212 obtains the AP information stored in the memory such as the RAM 214 in S702 and/or S711. Also, the CPU 212 may obtain the received signal strength indicator (RSSI) and signal-noise ratio (SNR) from the wireless unit 250.

Next, in S713 to S716, the CPU 212 uses the value obtained in S712 to determine the display method of the information indicating the signal strength of the connected AP.

In S713, the CPU 212 uses the value obtained in S712 to determine whether or not it is operating with the wireless infrastructure communication mode enabled. In a case where the CPU 212 determines that it is operating with the wireless infrastructure communication mode enabled, the processing advances to S714. Otherwise, the processing advances to S720.

In S714, the CPU 212 determines whether or not the communication method used in communication with the AP is the multi-AP method. In a case where the CPU 212 determines that the communication method is multi-AP communication on the basis of the value obtained in S712, the processing advances to S715. Otherwise, the processing advances to S721.

In S715, the CPU 212 determines whether or not the communication method used in communication with the AP is the joint-TX method of multi-AP communication. In a case where the CPU 212 determines that the communication method is the joint-TX method on the basis of the value obtained in S712, the processing advances to S721. Otherwise, the processing advances to S716.

In S716, the CPU 212 determines whether or not the communication method used in communication with the AP is the Co-OFDMA method of multi-AP communication. In a case where the CPU 212 determines that the connection method with the AP is the Co-OFDMA method on the basis of the value obtained in S712, the processing advances to S717. Otherwise, the processing advances to S721.

In S717, the CPU 212 determines whether the display region of the AP information is smaller than a predetermined size. In a case where the CPU 212 determines that it is smaller, the processing advances to S721. Otherwise, the processing advances to S718. Depending on the display state (display screen), the size of the region used to display the AP information differs. Thus, in S717, processing is executed to determine what is the current display state (display screen). Note that the determination of S717 may be omitted.

In a state in which the MFP 100 can perform multi-AP communication, there may be times when the MFP 100 is connected to a plurality of APs. In a case where the MFP 100 is connected to a plurality of APs and the display region is smaller than the predetermined size, there is a possibility that it may be difficult for the user to perceive the AP information if the AP information of the plurality of connected APs is displayed. Also, there is a possibility that all of the AP information cannot be displayed in the display region. Regarding this, in the present embodiment, in a case where the display region is determined to be smaller than the predetermined size in S717, the processing advances to S721 and the AP information is summarized and displayed.

In S718, the CPU 212 determines whether or not the display region of the AP information is the home screen. In a case where the CPU 212 determines that it is the home screen, the processing advances to S721. Otherwise, the processing advances to S719. Note that the determination of S718 may be omitted.

The display region of the AP information on the home screen is the network display region 321 of FIG. 3A, for example. Also, as described above, in a state in which the MFP 100 can perform multi-AP communication, there may be times when the MFP 100 is connected to a plurality of APs. In a case where the MFP 100 is connected to a plurality of APs, there is a possibility that the display space is insufficient to display each piece of AP information in the network display region 321. Regarding this, in the present embodiment, in a case where the display region is determined to be the home screen in S718, the AP information is summarized and displayed via the processing of S721 described below.

In S719, the CPU 212 references the permission (role) of the login user and determines whether or not the user currently logged into the MFP 100 is a user with permission to change the communication mode settings (network settings of the MFP 100). In a case where the CPU 212 determines that the user is a login user with permission to change the settings, the processing advances to S722. Otherwise, the processing advances to S721. Note that the determination of S719 may be omitted.

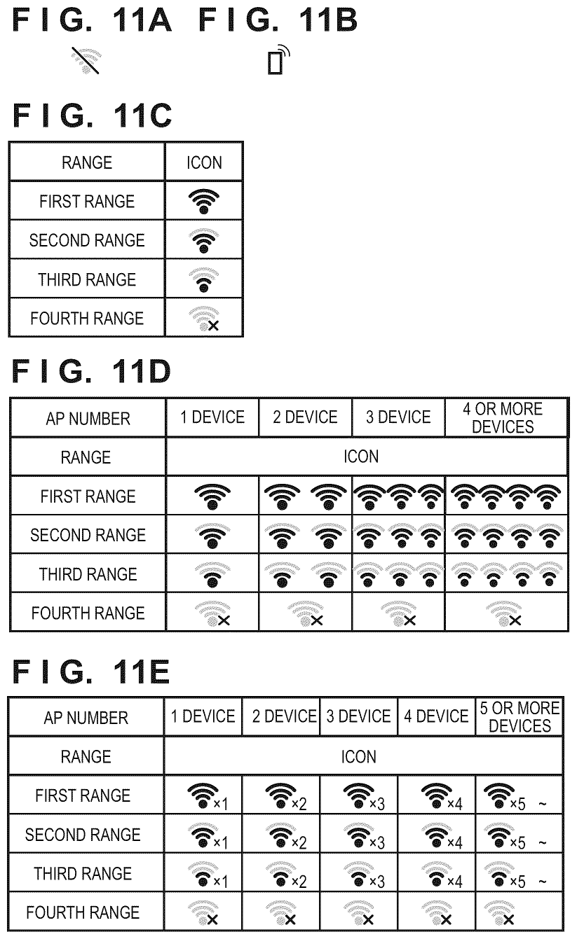

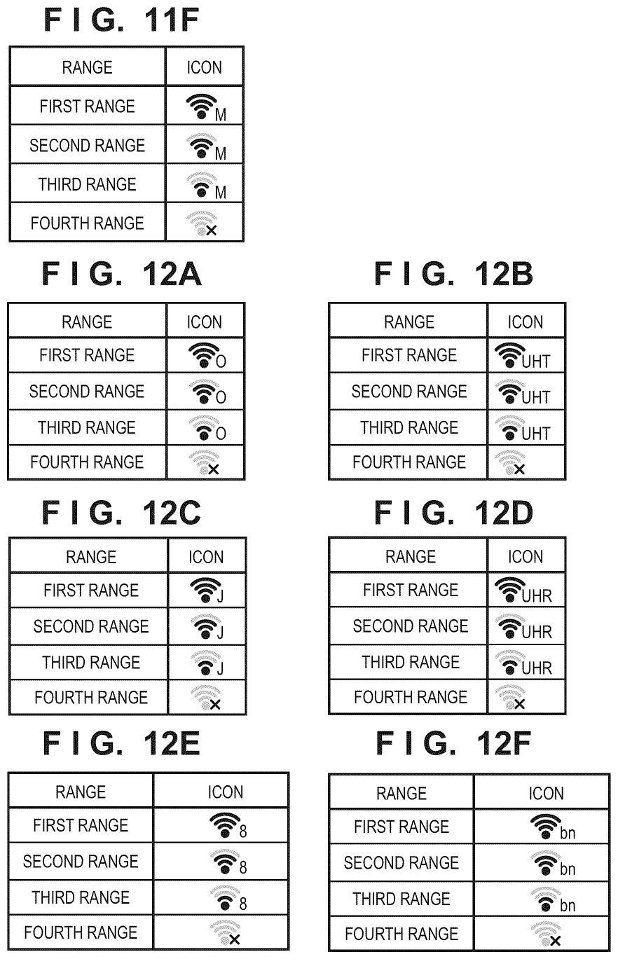

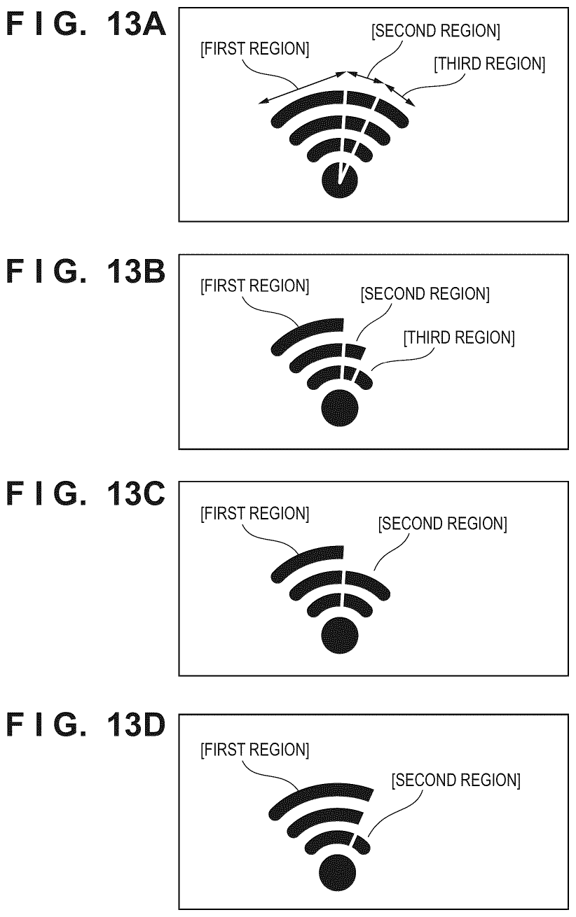

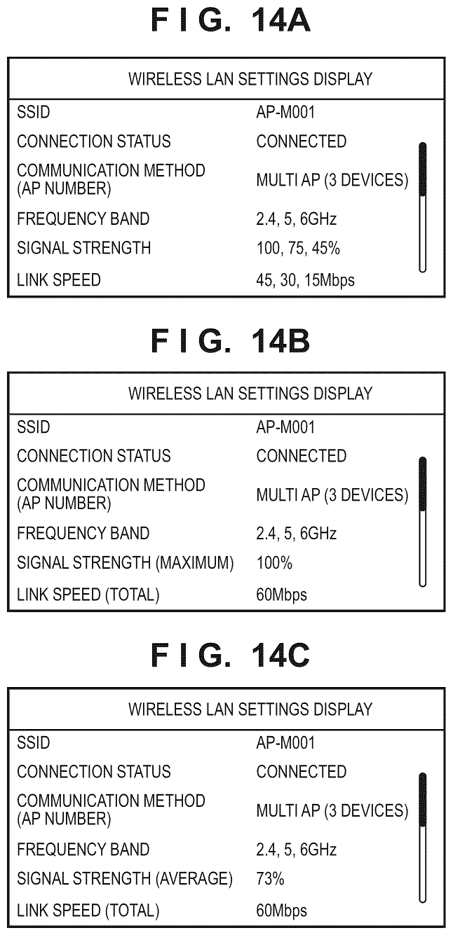

In S720, the CPU 212 displays information indicating that the wireless infrastructure mode is disabled. For example, the CPU 212 displays an icon indicating the wireless infrastructure connection status (disconnected) in the network display region 321 of FIG. 3A, and the processing ends. FIG. 11A illustrates an example of an icon indicating that the wireless infrastructure mode is in a disabled state. Also, the CPU 212 may display character information indicating that the wireless infrastructure mode is disabled on the wireless LAN settings display screen. FIGS. 14A to 14C illustrate examples of the wireless LAN settings display screen. The wireless LAN settings display screen is a screen that displays the status of settings relating to the wireless LAN of the MFP 100. On the wireless LAN settings display screen, “SSID”, “Connection status”, “Communication method (no. of APs)”, “Frequency band”, “Received signal strength indicator”, “Link speed”, and the like are displayed as display items. In other words, the wireless LAN settings display screen may be considered a screen for displaying the status of settings relating to the wireless LAN of the MFP 100 in more detail than the home screen of FIG. 3A. In S720, as the content corresponding to “Connection status”, the CPU 212 may display the character information of “Disconnected”, “Unconnected”, or the like indicating that the wireless infrastructure mode is disabled.

In S721, the CPU 212 summarizes and displays the information of the AP currently connected in the wireless infrastructure mode. Note that in a case where “no” is determined in S714, the MFP 100 is not performing multi-AP communication with APs and is connected to a single AP. Thus, in a case where “no” is determined in S714, in S721, the processing corresponds more to displaying the connection status with the single connected AP than summarizing and displaying the information of the plurality of APs connected via the wireless infrastructure mode.

On the other hand, in a case where “yes” is determined in S714 and the processing of S721 is executed, the MFP 100 is performing multi-AP communication and is connected to a plurality of APs. However, instead of the information of each of the plurality of connected APs being displayed, the information relating to the plurality of connected APs is summarized and displayed.

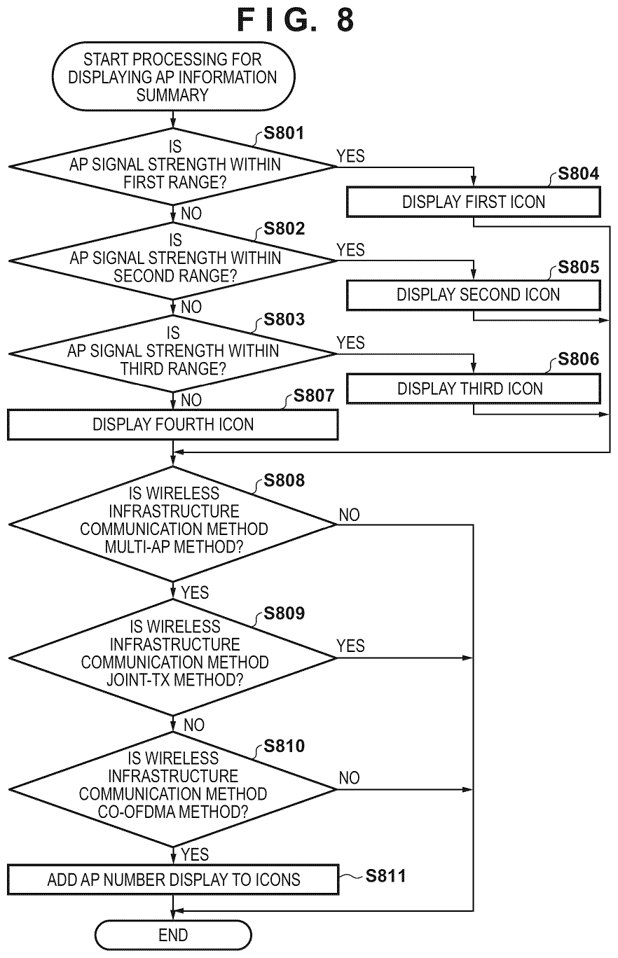

In S721, in a case where the display destination of the AP information is the home screen of FIG. 3A, for example, the CPU 212 displays a single icon indicating the wireless infrastructure connection status (connected) in the network display region 321. At this time, as illustrated in FIG. 11C, a single different icon is displayed depending on the connection status with the AP. Also, in a case where the display destination of the AP information is the wireless LAN settings display screen illustrated in FIG. 14A, the CPU 212 displays character information such as “Connected” as the content corresponding to the “Connection status”. The processing of S721 is described below in detail with reference to FIG. 8. Note that even with the same connection status, in a case where the display destination of the AP information is the wireless LAN settings display screen, as illustrated in FIG. 14B, a value which is the sum of the maximum value for the received signal strength indicator and the link speed of each of the APs may be displayed. Also, as illustrated in FIG. 14C, the average value of the received signal strength indicator of each of the APs may be displayed. In other words, in the wireless LAN settings display screen, if the current connection is via the multi-AP method regardless of whether it is the joint-TX method or the Co-OFDMA, information relating to, of the detected APs, the plurality of coordinated APs (the plurality of access points corresponding to targets for multi-AP communication) belonging to the same multi-AP group as the currently connected AP of the multi-AP method is displayed.

In S722, the CPU 212 displays the AP information of the connection destination of the wireless infrastructure mode without summarizing it. In other words, in S722, the CPU 212 displays the information of each of the plurality of APs the MFP 100 is currently connected to. Furthermore, in S722, information relating to the plurality of APs corresponding to the target of multi-AP communication is displayed. For example, in a case where the display destination of the AP information is the home screen of FIG. 3A, as illustrated in FIG. 11D, icons corresponding to the received signal strength indicator of each of the plurality of APs usable in parallel in communication with the MFP 100 may be displayed next to one another in the network display region 321. Also, even with the same connection status, in a case where the display destination of the AP information is the wireless LAN settings display screen of FIG. 14A, as illustrated, the received signal strength indicator, the frequency band, and the link speed of each of the APs may be displayed. In the example of FIG. 14A, three coordinated APs are connected to the MFP 100, and each of the frequency band/received signal strength indicator/link speed are 2.4 GHz/100%/45 Mbps for the first coordinated AP that is connected, 5 GHz/75%/30 Mbps for the second coordinated AP that is connected, and 6 GHz/45%/15 Mbps for the third coordinated AP that is connected.

Note that at least one of S714 to S719 in the processing of FIG. 7B described above may be omitted. In a case where all are omitted and “yes” is determined in S713, the processing of S721 is executed. In other words, in a case where at least one of S714 to S719 is omitted, the AP information is summarized and display and the processing of FIG. 8 is started regardless of at least one (all or one or more) of the following conditions:
Multi-AP method or not (S714)
Joint-TX method or not (S715)
Co-OFDMA Method or Not (S716)
Is the AP information display region smaller than the predetermined size (S717)
Is the AP information display region the home screen (S718)
Is the logged-in user a user with permission to change the communication mode settings (S719)

Note that in a case where all of S714 to S719 are omitted and “yes” is determined in S713, the processing of S722 may be executed.

In S723, the CPU 212 determines whether or not there is currently a connection with an AP via the wireless infrastructure mode. In S723, the CPU 212 determines this on the basis of the value obtained in S712. For example, in a case where the MFP 100 receives a beacon frame or a probe response from an AP within a certain period of time, the CPU 212 determines that the MFP 100 is connected to an AP and the processing advances to S712. Otherwise, the CPU 212 determines that the MFP 100 is disconnected from an AP (a change from a connected state to a disconnected state) and the processing advances to S724.

In S724, the CPU 212 stores the AP information in the RAM 214 and/or the non-volatile memory 215 as in S702 and S711. In S724, the AP information stored in the memory such as the RAM 214 includes information indicating the connection status with the AP information (disconnected).

FIG. 8 is a flowchart for describing the processing of S721. The processing in the flowchart illustrated in FIG. 8 is implemented by the CPU 212 of the MFP 100 loading various types of programs stored in the computer-readable memory of the ROM 213 onto the RAM 214 and executing the programs.

In S801 to S803, the CPU 212 confirms the range of the received signal strength indicator of the connection destination AP, and in S804 to S807, the CPU 212 performs a display corresponding to the received signal strength indicator.

In S801, the CPU 212 determines whether or not the received signal strength indicator of the AP calculated on the basis of the RSSI obtained from the AP in S712 of FIG. 7B is within a first range. In a case where the CPU 212 determines that it is within the first range, the processing advances to S804. Otherwise, the processing advances to S802.

In S802, the CPU 212 determines whether or not the received signal strength indicator of the AP calculated on the basis of the RSSI obtained from the AP in S712 of FIG. 7B is within a second range. In a case where it is within the second range, the CPU 212 advances the processing to S805. Otherwise, the CPU 212 advances the processing to S803.

In S803, the CPU 212 determines whether or not the received signal strength indicator calculated on the basis of the RSSI obtained from the AP in S712 of FIG. 7B is within a third range. In S803, in a case where it is within the third range, the CPU 212 advances the processing to S806. Otherwise (in a case where it is a fourth range), the CPU 212 advances the processing to S807. Note that the size relationship between the ranges of the received signal strength indicator is first range>second range>third range>fourth range.

In S804 to S807, the CPU 212 displays the icons corresponding to the received signal strength indicators.

In S804, the CPU 212 displays the icon corresponding to the first range.

In S805, the CPU 212 displays the icon corresponding to the second range.

In S806, the CPU 212 displays the icon corresponding to the third range.

In S807, the CPU 212 displays the icon corresponding to the fourth range.

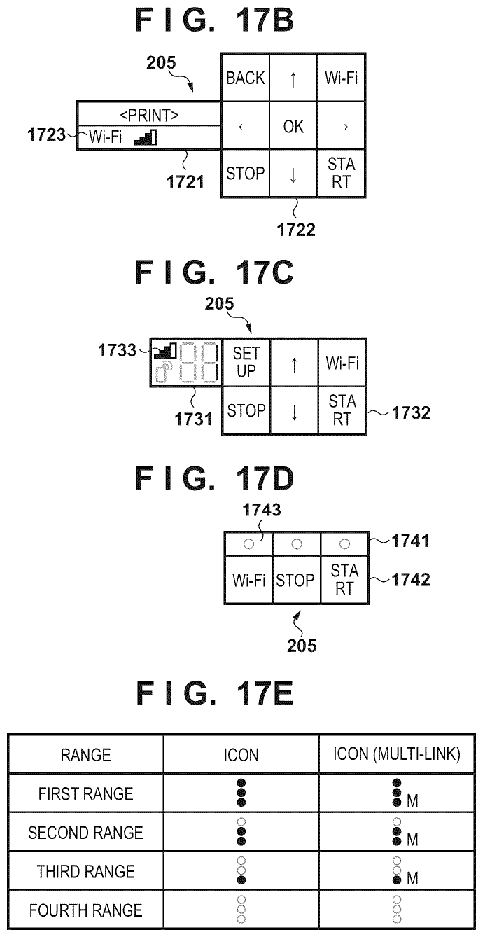

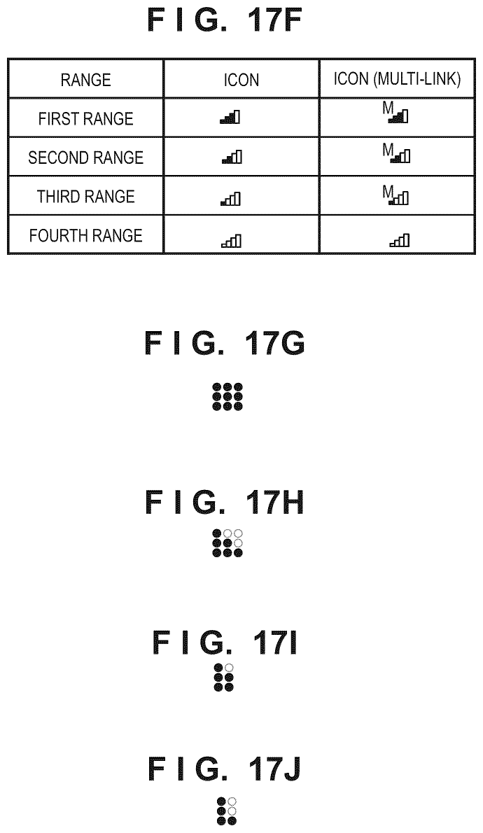

FIG. 11C illustrates an example of icons corresponding to each of the first range to the fourth range. The icons in FIG. 11C indicate the level of the received signal strength indicator of the AP the MFP 100 is connected to. The icons in FIG. 11C have a fan-shaped design, and the number of lines of the fan shape indicates the level of the received signal strength indicator of the connection destination AP. Note that the shape of the icon indicating the level of the received signal strength indicator is not limited to the fan-shape illustrated in FIG. 11C. For example, it is sufficient that the icon changes the display mode depending on the received signal strength indicator of the connection destination AP. Also, the icon may incrementally change depending on the received signal strength indicator of the connection destination AP. Specifically, the icons may be like the icons illustrated in FIG. 17F described below.

Next, in S808 to S810, the CPU 212 determines whether or not the conditions for displaying specific information (the number of connected APs) relating to the APs connected via multi-AP communication are matched.

In S808, the CPU 212 determines whether or not the communication method used in communication with the AP is the multi-AP communication method. In a case where the communication method is determined to be the multi-AP communication method on the basis of the value obtained in S712, the processing advances to S809. Otherwise, the processing of FIG. 8 ends without a display of the number of connected APs being performed.

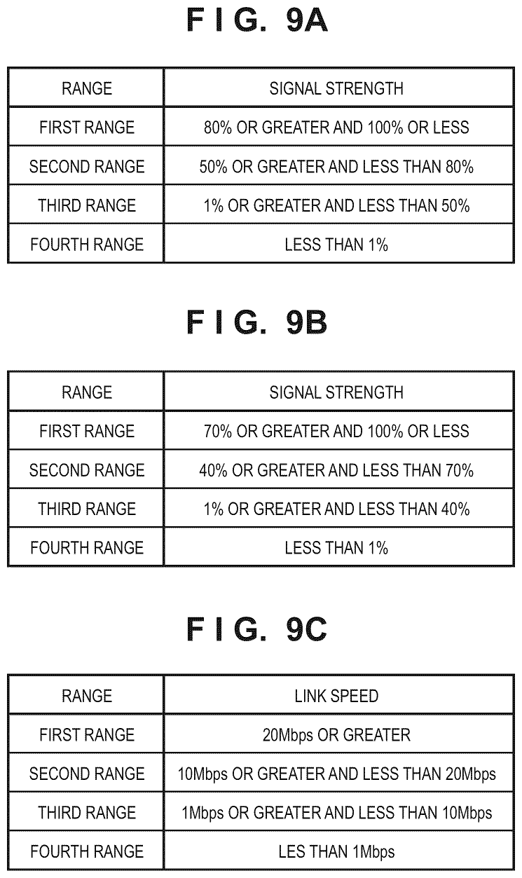

In S809, the CPU 212 determines whether or not the communication method used in communication with the AP is the joint-TX method of multi-AP communication. In a case where the CPU 212 determines that the communication method is the joint-TX method on the basis of the value obtained in S712, the processing of FIG. 9 ends. Otherwise, the processing advances to S810.

For the plurality of APs connected to the MFP 100, depending on the communication method, there are some cases where it is better that the information of each AP is displayed and some cases where it is better that it is not displayed. In the joint-TX method, a plurality of APs cooperate to perform communication with a single STA. Thus, even in a case where the MFP 100 is connected to a plurality of APs, there is a possibility that the number of APs (number of communication devices) that can be used in communication via the joint-TX method does not match. Also, in a case where the communication method is the joint-TX method, the communication speed does not increase proportionally with an increase in the number of communication devices. Thus, if information of each of the plurality of APs the MFP 100 is connected to is displayed, there is a possibility that the user may incorrectly think that the signal strength is better than it actually is. Regarding this, in the present embodiment, in a case where the communication method used to perform communication with the APs is the joint-TX method, the CPU 212 ends the processing of FIG. 8 without performing a display of the number of connected APs.

In S810, the CPU 212 determines whether or not the communication method used in communication with the AP is the Co-OFDMA method of multi-AP communication. In a case where the CPU 212 determines that the communication method with the APs is the Co-OFDMA method on the basis of the value obtained in S712, the processing advances to S811. Otherwise, the processing of FIG. 8 ends without a display of the number of connected APs being performed.

In the Co-OFDMA method, a plurality of APs cooperate, manage resources, and perform communication with the STA. Thus, when the number of APs connected to the MFP 100 increases, the communication speed increases. Regarding this, in the present embodiment, in a case where the communication method used to perform communication with the APs is the Co-OFDMA method, the processing advances to S811 and the CPU 212 performs a display of the number of connected APs.

In S811, the CPU 212 adds the information (specific information relating to the APs) according to the number of APs the MFP 100 is connected to the icons display via the processing of any of S804 to S807 for display. FIG. 11E illustrates examples of icons with the information according to the number of APs added. In the example of FIG. 11E, an icon is displayed with, as the information according to the number of connected APs, a number indicating the number of APs connected to the MFP 100 added. By displaying an icon with information according to the number of APs added, the user can identify whether the number of devices connected with multi-AP communication is large or small in each of the first range, the second range, and the third range for the received signal strength indicator. Thus, even if the received signal strength indicator is the second range or the third range instead of the first range, the state being a state in which the MFP 100 and a plurality of cooperatively operating APs are performing communication and the state being a state is which the signal-noise ratio may not be that bad can be recognized.

In this manner, in the present embodiment, in a case where the state is a state in which communication can be performed using the Co-OFDMA method via a plurality of APs belonging to a multi-AP group (yes in S810), the CPU 212 advances the processing to S811. In other words, the CPU 212 displays specific information relating to a plurality of APs belonging to a multi-AP group and outputs (displays) type information (a single display item) indicating the signal strength of the connected APs. On the other hand, in a case where the state is a state in which communication can be performed using the joint-TX method via a plurality of APs belonging to a multi-AP group (yes in S809), the CPU 212 ends the processing of FIG. 8 without advancing to S811. In other words, the CPU 212 does not display specific information relating to a plurality of APs belonging to a multi-AP group and outputs (displays) type information (a single display item) indicating the signal strength of the connected APs. Note that in the example of FIG. 11E, the specific information relating to the plurality of APs corresponds to a number indicating the number of APs connected to the MFP 100. Also, the type information is an icon in the example of FIG. 11E. Via such control, the type information relating to the APs can be appropriately output according to the communication method used for the MFP 100 to perform communication with the APs. Note that after S807 and before S808, as with S719, whether or not the logged-in user is a user with permission to change the communication mode settings is determined. In a case where “yes” is determined, the processing advances to S811. In a case where “no” is determined, the processing advances to S808. In other words, in a case where the logged-in user is a user that can change the network settings and communication via the joint-TX method and communication via the Co-OFDMA method can both be performed, the processing advances to S811 and control may be performed to display information relating to the plurality of access points which are targets for multi-AP communication.

Note that in the example of FIG. 11E, the number of connected devices in multi-AP communication is not displayed in the icons in a case where the received signal strength indicator is the fourth range. This is because a high signal-noise ratio cannot be expected even if the MFP 100 is connected to a plurality of APs with a low received signal strength indicator. In other words, even if the MFP 100 connects to a plurality of APs with a low received signal strength indicator, the signal strength will not be enhanced. Accordingly, in a case where the received signal strength indicator is the fourth range which is lower than the first to third ranges, in S811, the CPU 212 does not add the information according to the number of APs to the icon. In this manner, even if the number of APs (number of connected devices) connected to the MFP 100 is large, by not displaying the number of connected devices in a situation that cannot be considered to have good signal strength, the user can be prevented from incorrectly thinking that the signal strength is high due to the large number of connected devices displayed.

Note that in the example of FIG. 11E described above, as the specific information relating to the APs, a number indicating the number of APs the MFP 100 is connected to is added to the icons. However, no such limitation is intended. In other words, the method for adding information according to the number of APs is not limited thereto, and it is sufficient that the display changes depending on the number of APs.

FIGS. 13A to 13D illustrate other display examples of the situations displayed in FIG. 11E. The icons illustrated in FIGS. 13A to 13D are single icons (single items) that can indicate the level of the received signal strength indicator of each of the plurality of connection destination APs. As illustrated in FIGS. 13A to 13D, the icon is divided by the number of connected APs, with the level of the received signal strength indicator of each of the connection destination AP being represented in each region by the number of lines of the fan shape. In other words, the single item in FIGS. 13A to 13D indicates the signal strength of each of the plurality of APs that can be used in parallel for communication of the MFP 100 in a situation in which the MFP 100 can perform communication via the Co-OFDMA method for each of the plurality of regions obtained by dividing the single item.

FIGS. 13A and 13B illustrate examples in which the icon region is divided into three in a case where the MFP 100 is connected to three APs. The received signal strength indicator of each of the three connected APs is displayed in a first region to a third region as in FIGS. 13A and 13B. The order in which the APs are displayed in the first region to the third region may be in order from highest received signal strength indicator or in order from fastest link speed, for example. The width of the first region to the third region may be determined on the basis of the ratio of the link speed of each AP relative to the total link speed of the APs. FIG. 13A illustrates a display example in a case where the range of the received signal strength indicator of each of the APs is the first range. FIG. 13B illustrates a display example in a case where the range of the received signal strength indicator of each of the APs is the first range, the second range, and the third range.

FIGS. 13C and 13D illustrate examples in which the icon region is divided into two in a case where two APs are connected to. FIG. 13C illustrates a display example in a case where the range of the received signal strength indicator of each of the APs is the first range and the second range. FIG. 13D illustrates a display example in a case where the range of the received signal strength indicator of each of the APs is the first range and the third range.

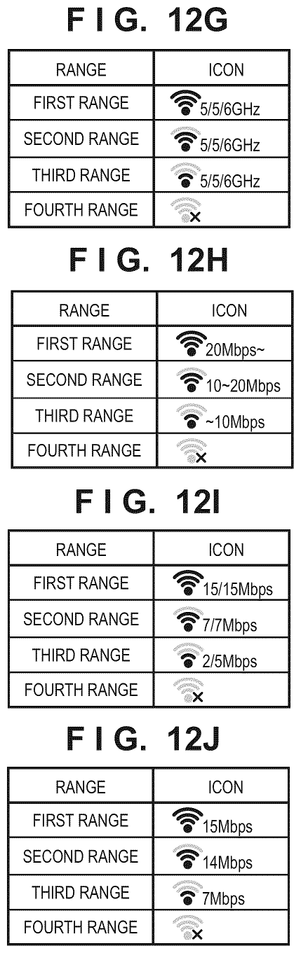

Also, the method for adding the information according to the number of APs may include, for example, displaying the frequency band of each of the plurality of coordinated APs connected via multi-AP communication as illustrated in FIG. 12G. Another method may include, for example, displaying the link speed of each of the plurality of coordinated APs connected via multi-AP communication as illustrated in FIG. 12I. Yet another method may include, for example, displaying a value of the total link speed of the plurality of coordinated APs connected via multi-AP communication as illustrated in FIG. 12J.

Note that the first range described above is a range in which wireless infrastructure communication can be stably performed. The second range is a range in which there is a possibility of unstable wireless infrastructure communication. The third range is a range in which there is a high possibility of unstable wireless infrastructure communication. The fourth range is a range in which wireless infrastructure communication cannot be performed or the connection with the APs will disconnect.

FIG. 9A illustrates an example of the first to fourth ranges. In this example, the first range corresponds to a case where the AP received signal strength indicator ranges from 80% to 100%, the second range corresponds to a case where the AP received signal strength indicator ranges from 50% to less than 80%, the third range corresponds to a case where the AP received signal strength indicator ranges from 1% to less than 50%, and the fourth range corresponds to a case where the received signal strength indicator is less than 1%.

Note that in S714 of FIG. 7B, in a case where the AP communication method is determined to be the multi-AP communication method, there is a possibility that the MFP 100 is simultaneously connected to a plurality of APs. In a case where the AP communication method is determined to be the multi-AP communication method in S714, for the value of the received signal strength indicator used for selecting an icon to display the AP information in the processing of FIG. 8, a value calculated from the values of the received signal strength indicators of the plurality of connected APs may be used.

For example, in a case where the MFP 100 is simultaneously connected to a plurality of APs, an icon corresponding to the maximum value for the received signal strength indicator of the APs may be displayed. In this case, if the received signal strength indicator of any of the APs from among the plurality of connected APs is in the first range, a first icon is displayed. In a similar manner, if the maximum value of the AP received signal strength indicator is in the second range, a second icon is displayed. In a similar manner, if the maximum value of the AP received signal strength indicator is in the third range, a third icon is displayed. In other cases, a fourth icon is displayed.

Also, in a case where the MFP 100 is simultaneously connected to a plurality of APs, the method for calculating the value of the received signal strength indicator used for selecting the icon is not limited thereto. For example, an icon corresponding to the average value for the received signal strength indicator of the APs may be displayed. FIG. 10C illustrates an example in a case where the MFP 100 is simultaneously connected to two coordinated APs. As illustrated in FIG. 10C, if the average value of the received signal strength indicators of the first AP and the second AP is within the first range, the first icon is displayed. In a similar manner, if the average value of the received signal strength indicators of the APs is in the second range, the second icon is displayed. In a similar manner, if the average value of the received signal strength indicators of the APs is in the third range, the third icon is displayed. If it is in the fourth range, the fourth icon is displayed.

Also, in a case where the MFP 100 is simultaneously connected to a plurality of APs, the range of the received signal strength indicator corresponding to each of the icons may be a range different from that in a case where the MFP 100 is connected to a single AP. For example, the range of the received signal strength indicator in a case where the MFP 100 is connected to a single AP may be the range illustrated in FIG. 9A. Also, the range of the received signal strength indicator in a case where the MFP 100 is connected to a plurality of APs may be the range illustrated in FIGS. 9B and 10D. In the example of FIGS. 9B and 10D, the first range corresponds to a case where the AP received signal strength indicator ranges from 70% to 100%, the second range corresponds to a case where the AP received signal strength indicator ranges from 40% to less than 70%, the third range corresponds to a case where the AP received signal strength indicator ranges from 1% to less than 40%, and the fourth range corresponds to a case where the received signal strength indicator is less than 1%.

Also in a case where the communication method between the MFP 100 and the connected APs is the multi-AP communication method and the MFP 100 is simultaneously connected to a plurality of APs, a display different from the icon (FIG. 11C) displayed when the MFP 100 is connected to a single AP may be displayed. For example, as illustrated in FIGS. 11F and 12A to 12G, a display indicating that a plurality of APs are simultaneously connected to may be added to the icon (FIG. 11C) indicating the received signal strength indicator for display.

FIG. 11F illustrates an example in which a display indicating that the current connection is via the multi-AP communication method may be added to the icon indicating the received signal strength indicator for display. As illustrated in FIG. 11F, a display such as “M”, “Multi-AP”, “Multi”, “Coop”, or “Cooperative mode” may be added to the icon (FIG. 11C) indicating the received signal strength indicator for display. In other words, information indicating that there are a plurality of APs that can be used in parallel in communication by the MFP 100 may be added for display.

Also in a case where the communication method between the MFP 100 and the connected APs is the multi-AP communication (Co-OFDMA) method and the MFP 100 is simultaneously connected to a plurality of APs, that the current connection is via the multi-AP (Co-OFDMA) method may be added to the icon (FIG. 11C) indicating the received signal strength indicator for display. For example, as illustrated in FIG. 12A, a display such as “O” or “Co-OFDMA” may be added to the icon (FIG. 11C) indicating the received signal strength indicator for display. Also, for example, as illustrated in FIG. 12B, a display such as “UHT”, “Ultra High Throughput”, “High Speed”, or “High Speed Mode” may be added to the icon (FIG. 11C) indicating the received signal strength indicator for display.

Also in a case where the communication method between the MFP 100 and the connected APs is the multi-AP communication (joint-TX) method and the MFP 100 is simultaneously connected to a plurality of APs, that the current connection is via the multi-AP (joint-TX) method may be added to the icon (FIG. 11C) indicating the received signal strength indicator for display. For example, as illustrated in FIG. 12C, a display such as “J” or “Joint-TX” may be added to the icon (FIG. 11C) indicating the received signal strength indicator for display. Also, for example, as illustrated in FIG. 12B, a display such as “UHR”, “Ultra High Reliability”, “High Reliability”, or “High Reliability Mode” may be added to the icon (FIG. 11C) indicating the received signal strength indicator for display.

Note that in the example described above relating to the processing of FIG. 8, an icon corresponding to the AP received signal strength indicator is displayed as the information of the AP that MFP 100 is connected to. Specifically, in the example described above relating to the processing of FIG. 8, the CPU 212 confirms the range of the received signal strength indicator of the connection destination AP and displays an icon such as that in FIG. 11C corresponding to the range of the received signal strength indicator such as that in FIG. 9A. However, no such limitation is intended. For example, an icon corresponding to the AP link speed may be displayed. For example, the CPU 212 may determine the range of the link speed of the connection destination AP in S801 to S803 of FIG. 8 and may display an icon corresponding to the range of the link speed according to the determination result. FIG. 9C illustrates an example of link speed ranges. In the example of FIG. 9C, the first range corresponds to a case where the link speed is 20 Mbps, the second range corresponds to a case where the link speed ranges from 10 Mbps to less than 20 Mbps, the third range corresponds to a case where the link speed ranges from 1 Mbps to less than 10 Mbps, and the fourth range corresponds to a case where the link speed is less than 1 Mbps. FIG. 12H illustrates an example of icons corresponding to the link speed ranges.

Also, in a case where the connection method between the MFP 100 and the connected APs is the multi-AP (Co-OFDMA) method and the MFP 100 is simultaneously connected to a plurality of APs, the link speeds of each of the plurality of coordinated APs connected via multi-AP communication may be totaled, and an icon (FIG. 12H) corresponding to the link speed range (FIG. 9C) may be displayed.

The display of an icon indicating the infrastructure connection status (signal strength) of the wireless LAN (Wi-Fi) described above is not limited to the MFP 100 and may be applied to various types of STA devices such as a smartphone.

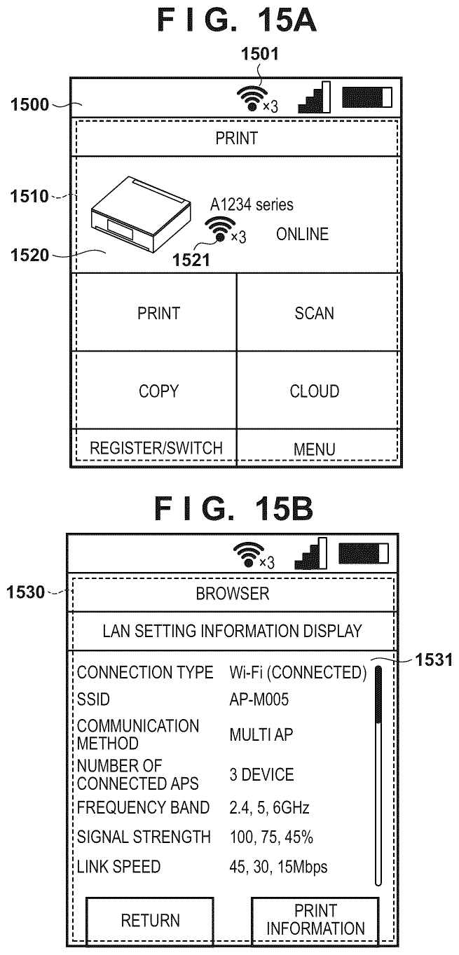

FIG. 15A illustrates an example of a display on the display unit 420 of the mobile terminal apparatus 101 which is a smartphone. A status bar 1500 is a display region indicating various status types of the mobile terminal apparatus 101. In the example of FIG. 15A, in order from the right, an icon indicating the remaining battery amount, an icon indicating the signal strength of the mobile communications (mobile phone line), and an icon 1501 indicating the communication status of Wi-Fi (infrastructure connection) are displayed. The status bar 1500 is a region displayed via control by the operating system (OS) of the mobile terminal apparatus 101 regardless of the active application running on the mobile terminal apparatus 101. In other words, regarding the display content of the status bar 1500, if the signal strength of the mobile terminal apparatus 101 is the same, the same icon 1501 is displayed even if the active application (app) switches from app A to app B. However, the status bar 1500 is not displayed in cases such as edge-to-edge when the entire screen is used to display the contents of the app (when the app contents are displayed using also the display region of the status bar 1500).

At the time when the icon 1501 indicating the connection information of Wi-Fi in the status bar 1500 is displayed, the present embodiment described above is applicable. The icon 1501 as illustrated in FIG. 11E described above is an icon in a case where the number of APs connected to the mobile terminal apparatus 101 via multi-AP communication is three and the range of the received signal strength indicator is the first range. Via the icon 1501, the user can recognize that the mobile terminal apparatus 101 is connected to three coordinated APs via the multi-AP communication method and that the received signal strength indicator is the first range (good).

Accordingly, the icon 1501 is displayed in the status bar 1500 depending on whether or not the mobile terminal apparatus 101 is performing (is in a state that can perform) multi-AP communication, the communication method of multi-AP communication, the number of connected coordinated APs, and the like. Note that the icon 1501 is not limited to the example of FIG. 15A, and as described in the embodiment described above, one of the icons illustrated in FIGS. 11A to 11F and 12A to 12J can be displayed according to the signal strength and the communication status of the mobile terminal apparatus 101.

The infrastructure connection status of the wireless LAN (Wi-Fi) of a first STA (for example, the MFP 100) described above is not limited to being displayed on the first STA and may also be displayed on a second STA (for example, the mobile terminal apparatus 101) that can perform communication with the first STA (the MFP 100).

A display region 1510 of FIG. 15A is a display example of a screen displayed by a printer application software (printing app) installed in the mobile terminal apparatus 101. When the printing app is started up and active, the content provided by the printing app is displayed in the display region 1510. In the display region 1510, a region 1520 is a status display region for displaying the status of the printer, which is the target device (control target device) for instructions from the mobile terminal apparatus 101. In the example described here, the MFP 100 is set as the instruction target device. In the example of FIG. 15A, a printer with a model series name (series name of the MFP 100) of A1234 series is registered and selected as the instruction target device. In the region 1520, an icon 1521 indicating the communication status of Wi-Fi (infrastructure connection) for the instruction target device and information indicating whether the mobile terminal apparatus 101 and the instruction target device are in a state (online) in which they can communicate are displayed.

The icon 1521 indicates the signal strength between the MFP 100 and the AP instead of the signal strength between the mobile terminal apparatus 101 and the AP. The mobile terminal apparatus 101 obtains the signal strength between the MFP 100 and the AP from the instruction target device via a specific protocol. The specific protocol is, for example, simple network management protocol (SNMP) or hypertext transfer protocol (HTTP). At the time when the icon 1521 indicating the communication status (connection information) of Wi-Fi of the instruction target device is displayed in the region 1520, the present embodiment described above is applicable. The icon 1521 as illustrated in FIG. 11E described above is an icon in a case where the number of APs connected via multi-AP communication is three and the range of the received signal strength indicator is the first range. Via the icon 1521, the user can recognize that the MFP 100, which is the control target, is connected to three coordinated APs via the multi-AP communication method and that the received signal strength indicator is the first range (good). Accordingly, relating to the signal strength, the icon 1521 is displayed in the region 1520 depending on whether or not the mobile terminal apparatus 101 is performing (is in a state that can perform) multi-AP communication, the communication method of multi-AP communication, the number of connected coordinated APs, and the like. Note that the icon 1521 is not limited to the example of FIG. 15A, and as described in the embodiment described above, one of the icons illustrated in FIGS. 11A to 11F and 12A to 12J can be displayed according to the signal strength and the communication status of the MFP 100.

On the printing app screen, in the section below the region 1520, icons indicating commands that can be instructed to the instruction target device are displayed. In the illustrated example, “Print”, “Scan”, “Copy”, and “Cloud” are displayed, and by operating these icons, the instruction target device (the MFP 100) can be caused to perform the corresponding operation. Also, the wireless LAN settings for the instruction target device can be displayed via the “Menu” icon in the lower section. The display content of the wireless LAN settings display displayed here is the set state of the wireless LAN settings for the MFP 100, which is the instruction target device, and a display similar to that in FIGS. 14A to 14C is performed.

Also, the instruction target device (control target device) information is not limited to a display by a printer app (application software for control) and can also be displayed by browser application software (a browser app) of the mobile terminal apparatus 101. By designating the IP address or URL of the MFP 100, which is the instruction target device, with the browser app of the mobile terminal apparatus 101, the content set in the MFP 100 can be obtained and displayed on the display unit 420.

FIG. 15B illustrates an example of the display of the MFP 100 settings content by the browser app. A region 1530 is a display example of a screen displayed by the browser app. Note that in a case where the browser app is started up and active, a region similar to the status bar 1500 described using FIG. 15A is displayed on the display unit 420. The region 1530 includes a region 1531. In the region 1531, the state of the wireless LAN settings of the MFP 100 obtained from the MFP 100 is displayed by the browser app. In the region 1531, content similar to that in FIGS. 14A to 14C can be displayed. In the example of FIG. 15B, a settings state similar to that of FIG. 14A is displayed in the region 1531, and that the MFP 100 is connected to three coordinated APs via the multi-AP communication method is indicated via items “Communication method” and “Number of connected APs”. The items such as “Frequency band”, “Received signal strength indicator”, and “Link speed” are similar to the displayed content in FIG. 14A.

Also, in the example described above, the infrastructure connection status (signal strength and the like) of the wireless LAN (Wi-Fi) is displayed. However, no such limitation is intended. In another example, the infrastructure connection status (signal strength and the like) of the wireless LAN (Wi-Fi) described above may be printed and output by the MFP 100.

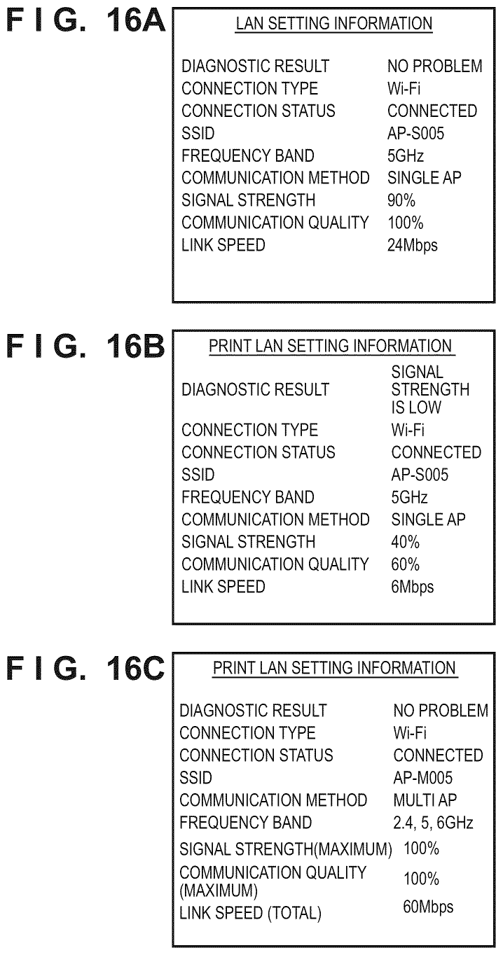

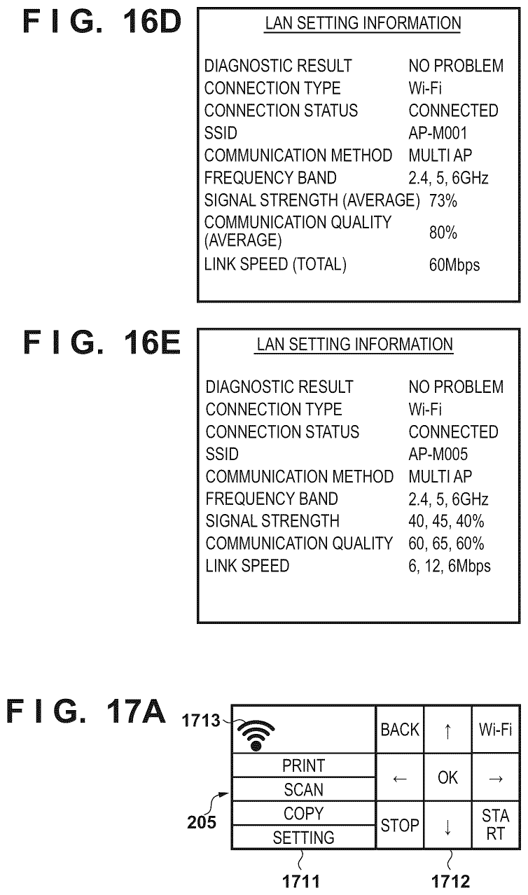

FIGS. 16A to 16E illustrate printing examples of the LAN settings printed by the MFP 100 in a case where “Print LAN settings” of FIG. 3B displayed on the MFP 100 or “Print information” of FIG. 15B displayed on the mobile terminal apparatus 101 is selected. FIGS. 16A to 16B illustrate printing examples of the LAN settings in a case where the MFP 100 is connected to a single AP and not performing multi-AP communication. FIGS. 16C to 16E illustrate examples of printed material of the LAN settings in a case where the MFP 100 is connected to a plurality of APs and performing multi-AP communication.

The printed material of the LAN settings includes, as printed items, “Diagnostic result”, “Connection type”, “Connection status”, “SSID”, “Communication method”, “Frequency band”, “Received signal strength indicator”, “Link speed”, and the like as illustrated in FIG. 16A. In addition to these items, items such as the IPv4 address and the IPv6 address may also be printed.

The information of the AP the MFP 100 is connected to may be switched to display the information of each of the APs summarized or not summarized according to the communication method between the MFP 100 and the connected APs as in the processing of FIGS. 7A and 7B. In the case of summarizing (a case of printing the LAN settings information with the condition for advancing to S721 of FIG. 7B being satisfied), as in the processing of FIG. 8, the maximum value or average value of the received signal strength indicator, the signal-noise ratio, and the link speed are printed as illustrated in FIGS. 16C and 16D. In the case of not summarizing (a case of printing the LAN settings information with the condition for advancing to S722 of FIG. 7B being satisfied), the value of the received signal strength indicator, the signal-noise ratio, and the link speed are printed as illustrated in FIG. 16E.

Note that in the case of printing the information of the APs the MFP 100 is connected to in FIGS. 16A to 16E, the icon (FIGS. 11A to 11F and FIGS. 12A to 12J) indicating the connection status between the MFP 100 and the APs may be printed according to the communication status of the MFP 100.

Also, in “Diagnostic result” of the LAN settings print, as illustrated in FIGS. 16A to 16E, the diagnostic result of a problem relating to the AP connected to the MFP 100 or the network is printed. Specifically, in a case where the received signal strength indicator of the AP that MFP 100 is connected to is high, character information such as “No problem” is printed. On the other hand, in a case where the received signal strength indicator of the AP that MFP 100 is connected to is low, character information such as “Poor received signal strength indicator” is printed.

Note that the range of the received signal strength indicator corresponding to “Poor received signal strength indicator” in “Diagnostic result” may be from the third range to the fourth range as illustrated in FIGS. 9A to 9B. Also, in a case where the MFP 100 is simultaneously connected to a plurality of APs via the multi-AP communication method, the range of the received signal strength indicator corresponding to “Diagnostic result” of the LAN settings print may be a range different from that in a case where the MFP 100 is connected to a single AP. For example, in a case where the MFP 100 is connected to a single AP, if the received signal strength indicator is in a range from 1% to less than 50% as illustrated in FIG. 9A, “Diagnostic result: Poor received signal strength indicator” may be printed. Also, for example, in a case where the MFP 100 is connected to two APs, if the received signal strength indicator is in a range from 1% to less than 40% as illustrated in FIG. 9B, “Diagnostic result: Poor received signal strength indicator” may be printed.

Note that in the present embodiment described above, the operation display unit 220 of the MFP 100 includes a touch panel display. However, no such limitation is intended.

FIG. 17A illustrates a first example of an operation display unit 205 included in the MFP 100 instead of or in addition to the operation display unit 220. The operation display unit 205 includes a display unit 1711 with a relatively narrow display region and an operation unit 1712 including a cursor key, enter key, or similar hardware keys. Specifically, the display unit 1711 is a dot matrix monochrome LCD that can display graphics. The display unit 1711 has a lower resolution than the touch panel of the operation display unit 220.

FIG. 17B illustrates a second example of the operation display unit 205 included in the MFP 100 instead of or in addition to the operation display unit 220. The operation display unit 205 of the second example includes a display unit 1721 with a narrower display region than the first example illustrated in FIG. 17A and an operation unit 1722 including a cursor key, enter key, or similar hardware keys. Specifically, the display unit 1721 is a dot matrix character LCD that can display limited characters and symbols. The display unit 1721 has a lower resolution than the display unit 1711.

FIG. 17C illustrates a third example of the operation display unit 205 included in the MFP 100 instead of or in addition to the operation display unit 220. The operation display unit 205 of the third example includes a display unit 1731 which is more limited in the information it can display than the second example illustrated in FIG. 17B and an operation unit 1732 including a cursor key, enter key, or similar hardware keys. Specifically, the display unit 1731 is a segmented LCD 1733 that can display predetermined graphics, numbers, and characters.

As illustrated in FIGS. 17A to 17C, in a case where the operation display unit 205 includes a display unit with a relatively narrow display region, as described in the embodiment described above, a display indicating the connection status of Wi-Fi (infrastructure connection) may be performed and one of the icons illustrated in FIGS. 11C to 11F and 12A to 12J may be displayed according to the status. An icon 1713 of FIG. 17A is an icon indicating the connection status of Wi-Fi (infrastructure connection) and an icon of the first range of FIG. 11C. In other words, it indicates that the MFP 100 is not performing multi-AP communication and that the signal strength is the first range (good). In a case where the MFP 100 is performing multi-AP communication, one of the displays of FIGS. 11E to 11F and 12A to 12J may be performed.

Also, as illustrated in FIGS. 17A to 17C, in a case where the operation display unit 205 includes a display unit with a relatively narrow display region, the connection status of Wi-Fi (infrastructure connection) may be displayed in a display mode different from the icon illustrated in FIGS. 11C to 11F and 12A to 12J. For example, the icon may be displayed in a display mode such as that illustrated in FIG. 17E or 17F.

FIG. 17E is a table indicating the received signal strength indicator via a three-dot display status, with more black dots indicating a higher received signal strength indicator. Also, in a case where the character (symbol) “M” is added, this indicates that the MFP 100 is connected to APs via the multi-AP communication method (multi-AP connection). In a case where the character “M” is not added, this indicates that the MFP 100 is not connected to APs via the multi-AP communication method (no multi-AP connection).

FIG. 17F is a table indicating the received signal strength indicator via the darkened status of vertical bars of different heights, with more darkened vertical bars indicating a higher received signal strength indicator. Also, in a case where the character (symbol) “M” is added, this indicates that the MFP 100 is connected to APs via the multi-AP communication method (multi-AP connection). In a case where the character “M” is not added, this indicates that the MFP 100 is not connected to APs via the multi-AP communication method (no multi-AP connection).

Also, as illustrated in FIGS. 17G to 17J, a plurality of segments arranged vertically and horizontally (in a matrix) may be used to display the signal strength of each of the plurality of connected coordinated APs in the case of a multi-AP connection. Each column in FIGS. 17G to 17J corresponds to the signal strength of a different coordinated AP, and the number of darkened sections in the vertical direction indicates the signal strength of the coordinated AP of that column. For example, in the example of FIG. 17H, three coordinated APs are connected. The range of the received signal strength indicator of the first coordinated AP is the first range, and in a similar manner, the range of the second is the second range and the range of the third is the third range. This illustrates the same status as in FIG. 13B. In a similar manner, FIG. 17G illustrates the same status as in FIG. 13A, and FIGS. 17I to 17J illustrate the same status as in FIGS. 13C to 13D. In other words, the plurality of segments in FIGS. 17G to 17J indicate the signal strength of each of the plurality of APs that can be used in parallel for communication of the MFP 100 in a situation in which the MFP 100 can perform communication via the Co-OFDMA method for each of the plurality of regions obtained by dividing the single item.

FIG. 17D illustrates a fourth example of the operation display unit 205 included in the MFP 100 instead of or in addition to the operation display unit 220. The operation display unit 205 of the fourth example includes a light-emitting unit 1741 and an operation unit 1742 including a start key or a similar hardware key. The light-emitting unit 1741 includes three light-emitting units, each corresponding to three virtual keys included in the operation unit 1742. A light-emitting unit 1743 included in the light-emitting unit 1741 corresponds to the virtual key labelled Wi-Fi is used for displaying the connection status of the Wi-Fi infrastructure connection. Specifically, each light-emitting unit 1741 is a light-emitting diode (LED). In the operation display unit 205 of the fourth example, the connection status of the Wi-Fi infrastructure connection is displayed via the light-emitting pattern of the light-emitting unit 1743. For example, the ratio of the on-time per cycle in a flashing pattern changes according to the received signal strength indicator. A specific example is described below, for example.
(A1) When the received signal strength indicator is the first range, the on-time per time T of one cycle of the flashing pattern is set to T×( 4/4) (that is, the light is continually on without turning off).
(A2) When the received signal strength indicator is the second range, the on-time per time T of one cycle of the flashing pattern is set to T×(¾) (that is, the light turns off for time corresponding to T×(¼)).
(A3) When the received signal strength indicator is the third range, the on-time per time T of one cycle of the flashing pattern is set to T×( 2/4) (that is, the light turns off for time corresponding to T×( 2/4)).
(A4) When the received signal strength indicator is the fourth range, the on-time per time T of one cycle of the flashing pattern is set to T×(¼) (that is, the light turns off for time corresponding to T×(¾)).

In all of (A1) to (A4), whether or not there is a multi-AP connection is indicated by the color of the emitted light. For example, in a case where the MFP 100 is performing a multi-AP connection, a green light turns on. Otherwise (in a case where the MFP 100 is connected to a single AP), a red light turns on.

Also, whether there is a multi-AP connection and the status of the received signal strength indicator may be indicated by only a light-emitting pattern and not a difference in emitted light color. An example is described below, for example.
(B1) When the received signal strength indicator is the first range and there is a multi-AP connection, the on-time per time T of one cycle of the flashing pattern is set to T×( 4/4) (that is, the light is continually on without turning off).
(B2) When the received signal strength indicator is the second range and there is a multi-AP connection, the on-time per time T of one cycle of the flashing pattern is set to T×(¾) (that is, the light turns off for time corresponding to T×(¼)). Also, when the received signal strength indicator is the first range and there is a single-AP connection and not a multi-AP connection, the same light-emitting pattern is set.
(B3) When the received signal strength indicator is the third range and there is a multi-AP connection, the on-time per time T of one cycle of the flashing pattern is set to T×( 2/4) (that is, the light turns off for time corresponding to T×( 2/4)). Also, when the received signal strength indicator is the second range and there is a single-AP connection and not a multi-AP connection, the same light-emitting pattern is set.
(B4) When the received signal strength indicator is the fourth range and there is a multi-AP connection, the on-time per time T of one cycle of the flashing pattern is set to T×(¼) (that is, the light turns off for time corresponding to T×(¾)). Also, when the received signal strength indicator is the third range and there is a single-AP connection and not a multi-AP connection, the same light-emitting pattern is set. Also, when the received signal strength indicator is the fourth range and there is a single-AP connection and not a multi-AP connection, the same light-emitting pattern is set.

With (B1) to (B4), in a case where there is a multi-AP connection, compared to when there is not, the ratio of the on-time is larger even if the received signal strength indicator is the same. This is because in the case of a multi-AP connection, enhanced communication throughput and reliability can be expected even with the same received signal strength indicator.

The indicating is not limited to the examples described above, and the received signal strength indicator and whether or not there is a multi-AP connection may be indicated by different light-emitting patterns.

As described above, according to the present embodiment, in the case of displaying the signal strength information of the AP the MFP 100 is connected to, the CPU 212 switches the AP information display method on the basis of the communication method with the connected AP. The CPU 212 performs control so that the information of the AP connected via multi-AP is displayed without summary in a case where the communication method with the connected AP is the multi-AP Co-OFDMA method and so that the AP information is displayed summarized in a case where the communication method is the joint-TX method. Via such control, information indicating the signal strength can be appropriately displayed according to the communication method and communication status between the MFP 100 and the AP. Also, even with a wireless communication apparatus with a limited display region for example, the connection status with the AP can be efficiently displayed.

According to the present disclosure the usability can be enhanced in the case of communication via a predetermined communication method.

Note that the various types of control described above performed by the CPU of each apparatus may be performed by a single piece of hardware or the processing may be shared by a plurality of pieces of hardware (for example, a plurality of processors and circuits) to perform control of the entire apparatus.

Also, preferred embodiments according to the present disclosure have been described above. However, the present disclosure is not limited to these specific embodiments and include various embodiments without departing from the scope of the claims. Furthermore, the embodiments described above are each merely embodiments of the present disclosure, and the embodiments can be combined as appropriate.

Also, in the embodiment described above, an example of the present disclosure applied to an MFP has been described. However, no such limitation is intended, and any wireless device that can perform multi-AP communication may be used. In other words, the present disclosure is applicable to a personal computer, a PDA, a tablet terminal, a smartphone or similar mobile phone terminal, a music player, a game console, an electronic book reader, a smartwatch, and various types of measurement apparatuses (sensor apparatuses) such as a thermometer and a hygrometer. Also, the present disclosure is applicable to a digital camera (including a still camera, a video camera, a network camera, and a security camera), a printer, a scanner, and a drone. Also, the present disclosure is applicable to an image output apparatus, an audio output apparatus (for example, a smart speaker), a media streaming player, and a wireless LAN client (adapter) that can connect to a USB terminal or a LAN cable terminal. An image output apparatus includes an apparatus such as a set top box, for example, that obtains (downloads) moving image and still images from the Internet specified by a URL in an instruction from a communication apparatus and outputs these to a display device connected via a HDMI (trademark) image output terminal or the like. In this manner, streaming playback is achieved on a display device, and mirroring display (displaying content displayed on a communication apparatus also on a display device) is achieved. Also, the image output apparatus includes a television, hard disk recorder, Blu-ray recorder, DVD recorder, or similar media player; a head-mounted display, a projector, a television, a display apparatus (monitor), and a signage apparatus. Also, the present disclosure is applicable to a device that can connect via Wi-Fi to an air conditioner, a refrigerator, a washing machine, a vacuum cleaner, an oven, an electronic microwave, a lighting fixture, a heating device, a cooling device, or any so-called smart home appliances.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-233116, filed Dec. 27, 2024 which is hereby incorporated by reference herein in its entirety.

What is claimed is:

1. A communication apparatus comprising,
at least one memory and at least one processor which function as:
a communication unit configured to perform wireless LAN communication with a plurality of access points that operate in cooperation and transmit and receive content data; and
a control unit configured to perform control to:
in a case of a first status in which communication can be performed by a first communication method via a plurality of access points belonging to a first group, output first type information both indicating specific information relating to the plurality of access points belonging to the first group and indicating a signal strength of a connected access point, and
in a case of a second status in which communication can be performed by a second communication method via a plurality of access points belonging to a second group, output second type information indicating a signal strength of a connected access point and not indicating the specific information relating to the plurality of access points belonging to the second group.

2. The communication apparatus according to claim 1, wherein the first communication method is a communication method in which each of the plurality of access points belonging to the first group performs communication with the communication apparatus using a different resource unit.

3. The communication apparatus according to claim 1, wherein the first communication method is a coordinated-orthogonal frequency division multiple access (Co-OFDMA) method of multi-AP communication compliant with an IEEE 802.11 series standard.

4. The communication apparatus according to claim 1, wherein the second communication method is a communication method in which radio waves transmitted from the plurality of access points belonging to the second group are combined so as to be amplified at a position of the communication apparatus.

5. The communication apparatus according to claim 1, wherein the second communication method is a joint transmission (joint-TX) method of multi-AP communication compliant with an IEEE 802.11 series standard.

6. The communication apparatus according to claim 1, wherein the specific information is at least one of:
information indicating that there is a plurality of access points that can be used in parallel to perform communication with the communication apparatus,
information indicating a total number of the plurality of access points that can be used in parallel to perform communication with the communication apparatus,
information corresponding to a received signal strength indicator of each of the plurality of access points that can be used in parallel to perform communication with the communication apparatus,
information indicating a communication method used by the plurality of access points that can be used in parallel to perform communication with the communication apparatus,
information indicating a frequency band of each of the plurality of access points that can be used in parallel to perform communication with the communication apparatus,
information corresponding to a link speed of each of the plurality of access points that can be used in parallel to perform communication with the communication apparatus, and
information that is based on a value obtained as a sum of the link speeds of the plurality of access points that can be used in parallel to perform communication with the communication apparatus.

7. The communication apparatus according to claim 1, wherein the specific information includes information relating to a plurality of coordinated APs belonging to the first group and does not include information relating to a plurality of coordinator APs belonging to the first group.

8. The communication apparatus according to claim 1, wherein the first type information is a single icon indicating both the specific information and the signal strength.

9. The communication apparatus according to claim 1, wherein the first type information is an icon in which a character indicating the specific information is added to a fan-shaped design indicating the signal strength.

10. The communication apparatus according to claim 1, wherein the first type information is a plurality of icons respectively corresponding to received signal strength indicators of the plurality of access points that can be used in parallel to perform communication with the communication apparatus.

11. The communication apparatus according to claim 1, wherein the second type information is a single icon indicating the signal strength of the connected access point and not indicating the specific information.

12. The communication apparatus according to claim 1, wherein the control unit performs control to:
differentiate whether to display the first type information or display the second type information on a first screen between the first status and the second status, and
display information relating to a plurality of access points included in a group corresponding to a multi-AP communication target on a second screen in both the first status and the second status, the second screen being different from the first screen and displaying a status of settings relating to wireless LAN in more detail than the first screen.

13. The communication apparatus according to claim 1, wherein the control unit performs control to:
differentiate whether to display the first type information or display the second type information on a first screen between the first status and the second status,
in a case where a user logged into the communication apparatus is not permitted to change a network setting, differentiate whether to display the first type information or display the second type information on a second screen different from the first screen between the first status and the second status, and
in a case where the user logged into the communication apparatus is permitted to change a network setting, display information relating to a plurality of access points corresponding to a multi-AP communication target in both the first status and the second status.

14. The communication apparatus according to claim 1, wherein
the control unit performs control to display the first type information or the second type information in accordance with the first status and the second status in a region displayed both in a case where a first application software is active and in a case where a second application software is active.

15. The communication apparatus according to claim 14, wherein the communication apparatus is a mobile terminal, and
the control unit performs control to display the first type information or the second type information in accordance with the first status and the second status in a status bar displaying a remaining battery amount of the communication apparatus.

16. The communication apparatus according to claim 1, wherein the control unit performs control to display a signal strength of an external apparatus that can perform communication with the communication apparatus,
in a case where the external apparatus can perform communication by the first communication method via the plurality of access points belonging to the first group, the signal strength of the external apparatus is the first type information both indicating the specific information relating to the plurality of access points belonging to the first group and indicating a signal strength of an access point to which the external apparatus is connected, and
in a case where the external apparatus can perform communication by the second communication method via the plurality of access points belonging to the second group, the signal strength of the external apparatus is the second type information indicating a signal strength of an access point to which the external apparatus is connected and not indicating the specific information relating to the plurality of access points belonging to the second group.

17. The communication apparatus according to claim 1, wherein the output is printing.

18. The communication apparatus according to claim 1, wherein the first communication method and the second communication method are each a communication method compliant with IEEE 802.11bn.

19. A method executed in a communication apparatus, comprising:
performing wireless LAN communication with a plurality of access points that operate in cooperation and transmit and receive content data; and
performing control to:
in a case of a first status in which communication can be performed by a first communication method via a plurality of access points belonging to a first group, output first type information both indicating specific information relating to the plurality of access points belonging to the first group and indicating a signal strength of a connected access point, and
in a case of a second status in which communication can be performed by a second communication method via a plurality of access points belonging to a second group, output second type information indicating a signal strength of a connected access point and not indicating the specific information relating to the plurality of access points belonging to the second group.

20. A non-transitory computer-readable storage medium storing a program configured to cause a computer to function as:
a communication unit configured to perform wireless LAN communication with a plurality of access points that operate in cooperation and transmit and receive content data; and
a control unit configured to perform control to:
in a case of a first status in which communication can be performed by a first communication method via a plurality of access points belonging to a first group, output first type information both indicating specific information relating to the plurality of access points belonging to the first group and indicating a signal strength of a connected access point, and
in a case of a second status in which communication can be performed by a second communication method via a plurality of access points belonging to a second group, output second type information indicating a signal strength of a connected access point and not indicating the specific information relating to the plurality of access points belonging to the second group.
